(19) United States
(12) Patent Application Publication
(10) Pub. No.: US 2024/0281509 A1
(43) Pub. Date: Aug. 22, 2024

(54) System and Methods for Age Verification Using a Unique Identifier of a User Device

(71) Applicant: Next Generation Technologies Inc., New York, NY (US)

(72) Inventors: Dimitrios Mavrofridis, Athens (GR); John Michael Mavrofridis, Athens (GR)

(73) Assignee: Next Generation Technologies Inc., New York, NY (US)

(21) Appl. No.: 18/343,158

(22) Filed: Jun. 28, 2023

Related U.S. Application Data
(60) Provisional application No. 63/485,376, filed on Feb. 16, 2023.
(60) Provisional application No. 63/501,860, filed on May 12, 2023.

(51) Int. Cl. G06F 21/32; G06Q 30/0207

(52) U.S. Cl. CPC G06F 21/32; G06Q 30/0224

(57) ABSTRACT

A method is provided. The method comprises: receiving, by an age verification system and from a client computing device via a user device, user data; comparing, by the age verification system, the user data with one or more lists; based on the comparison, providing, by the age verification system, one or more authorization requests to verify the user is of legal age for the gambling activity; in response to providing the one or more authorization requests, obtaining, by the age verification system, verification information associated with the user; and based on the verification information, providing, by the age verification system and to the client computing device, authorization information indicating the age of the user is of the legal age to perform the gambling activity.

### CROSS-REFERENCE TO RELATED APPLICATIONS

This patent application claims the benefit of U.S. Provisional Patent Application No. 63/485,376, filed Feb. 16, 2023, and U.S. Provisional Patent Application No. 63/501,860, filed May 12, 2023, both of which are incorporated by reference herein in their entireties.

### FIELD OF THE DISCLOSURE

The present disclosure relates to a method and system for software implemented processes and, more specifically, for software implemented processes relating to user authentication.

### BACKGROUND OF THE INVENTION

Age verification helps businesses accurately and reliably verify that their customers are of legal age to purchase and consume age restricted products and services such as alcohol, tobacco, or gambling. Age verification can also help protect businesses from potential legal and financial liabilities, maintain reputation and brand integrity, and avoid fines and other penalties associated with underage sales. Additionally, businesses may benefit from improved customer experiences and increased customer confidence in the products they are offering.

Most businesses that care about their protection and their customers apply the age verification process every time a customer buys a product that is regulated as an age-restricted product. There are several age verification methods, but they all have two things in common. The first one is that the customer must provide his/her authentication documents to the retailer to check them and decide whether the customer is eligible to buy an age-restricted product. The second one is that the process must be repeated every time the customer wants to buy an age-restricted product. Accordingly, there remains a technical need to facilitate age verification for businesses such that the customer does not need to provide his/her authentication documents each time while still allowing businesses to accurately and reliably verify that their customers are of legal age.

### SUMMARY

The present disclosure describes an age verification process, system, and/or method (e.g., an age verification system). The age verification system may use and/or include software such as a mobile application or web application, which may be in the form of computer executable instructions that is stored in tangible and non-volatile media. For instance, the instructions may be offered as either a downloadable stand-alone application (e.g., a Next Generation Technologies (NGT) application) and/or an application programming interface (API)/software development kit (SDK) that integrates with any of the client's business app and systems. As a result, this may significantly simplify the age verification process. For instance, by enrolling and using the age verification process, the customer may only need to use the biometric verification process that is associated with his or her mobile device (e.g., a smartphone) to confirm verification that the user is of legal age. For instance, the mobile device may be equipped with and/or supports biometric verification such as face verification and/or touch verification (e.g., a face verification or touch verification method that may be included within a mobile device available on the market). The age verification system may use the device's face and/or touch verification (e.g., the face or touch verification mechanism on the user device), which may allow for the customers' biometrics to be encrypted and hidden from a retailer. Additionally, and/or alternatively, by using the age verification system, the customer might not have to carry on and/or show his/her identifier (ID) authentication documents to the retailer every time that he/she wants to buy an age-restricted product, as they may be able to simply use their user device with their verified status to purchase and/or use products and/or services that require the user's age to be verified according to the product's or service's needs. Additionally, and/or alternatively, the age verification system may also apply to and/or be used by online businesses and/or self-service terminals (e.g., vending machines) that offer age restricted products and services.

A first aspect of the present disclosure provides a method comprising: receiving, by an age verification system and from a client computing device via a user device, user data, wherein the user device is associated with a user and the client computing device is associated with a gambling activity; comparing, by the age verification system, the user data with one or more lists, wherein the one or more lists are stored in one or more databases associated with the age verification system; based on the comparison, providing, by the age verification system, one or more authorization requests to verify the user is of legal age for the gambling activity; in response to providing the one or more authorization requests, obtaining, by the age verification system, verification information associated with the user; and based on the verification information, providing, by the age verification system and to the client computing device, authorization information indicating the age of the user is of the legal age to perform the gambling activity.

In some instances, the user data indicates a unique identifier for the user device, an email associated with the user, and/or at least a portion of a phone number associated with the user.

In some examples, the user data and the verification information associated with the user does not include any additional personal information of the user, and wherein the unique identifier is a mobile phone identifier (ID).

In some variations, the method further comprises: encrypting, by the user device, the unique identifier, the email associated with the user, and/or at least the portion of the phone number; generating, by the user device, the user data, wherein the user data comprises the encrypted unique identifier, the encrypted email, and/or at least the portion of the phone number; and providing, by the user device and to the age verification system, the user data.

In some instances, encrypting the unique identifier, the email associated with the user, and/or at least the portion of the phone number is based on using one or more hashing algorithms.

In some examples, the one or more lists comprise a whitelist and a yellow list, wherein the whitelist is stored in a verified users database and the yellow list is stored in a pending verification database, wherein the whitelist indicates one or more first users that have been previously verified to be of the legal age to perform the gambling activity, and wherein the yellow list indicates one or more second users that are pending verification for performing the gambling activity.

In some variations, comparing the user data with the one or more lists comprises determining that the user is on the whitelist, wherein obtaining the verification information comprises obtaining biometric verification information indicating that the user passed a biometric process performed by the user device, and wherein providing the authorization information is based on determining the user being on the whitelist and the biometric verification information indicating that the user passed the biometric process performed by the user device.

In some examples, the method further comprises: moving the user from the yellow list to the whitelist based on the document verification information and the biometric verification information.

In some variations, the method further comprises: moving an entry associated with the user from the yellow list to the whitelist based on the document verification information and the biometric verification information.

In some instances, the method further comprises: based on the verification information associated with the user, obtaining one or more unique identifiers for the user; and providing, to a client server, the one or more unique identifiers for the user.

In some examples, the verification information comprises document verification information indicating that the user passed a document identification check process and biometric verification information indicating that the user passed a biometric verification process, and wherein obtaining the one or more unique identifiers for the user comprises generating a first unique identifier for the user based on the document verification information and a second unique identifier for the user based on the biometric verification information.

In some variations, the method further comprises: based on the providing the one or more unique identifiers for the user, retrieving historical gambling activity data indicating previous gambling activities of the user; determining a promotional offer for the user based on the historical gambling activity data and the gambling activity associated with the client computing device; and generating, by the age verification system, the authorization information, wherein the authorization information comprises an indicator indicating that the age of the user is of the legal age to perform the gambling activity and the promotional offer.

In some instances, providing the one or more authorization requests comprises: providing a document check request indicating for the client computing device to verify a identifier (ID) document for the user is valid and the user is of the legal age for the gambling activity, and wherein obtaining the verification information comprises: obtaining, from the client computing device, a document verification result indicating the user is of the legal age for the gambling activity and the ID document for the user is valid.

In some examples, providing the one or more authorization requests further comprises: providing a biometric check request indicating that the user device belongs to the user, and wherein obtaining the verification information comprises: obtaining a biometric check result indicating that the user device belongs to the user.

In some variations, the method further comprises: receiving, from the user device, enrollment information indicating a first hashed value of a unique identifier associated with the user device and one or more second hashed values indicating a phone number or email address associated with the user; comparing the enrollment information with the one or more lists; generating an entry for the user, wherein the entry indicates the first hashed value and the one or more second hashed values; and including the entry on the one or more lists.

In some instances, receiving the user data comprises receiving, by the age verification system and from the client computing device via the user device and a client internet of things (IoT) device, the user data.

A second aspect of the present disclosure provides an age verification system, comprising: one or more processors; and one or more non-transitory computer-readable mediums having processor-executable instructions stored thereon, wherein the processor-executable instructions, when executed by the one or more processors, facilitate: receiving, from a client computing device via a user device, user data, wherein the user device is associated with a user and the client computing device is associated with a gambling activity; comparing the user data with one or more lists, wherein the one or more lists are stored in one or more databases associated with the age verification system; based on the comparison, providing one or more authorization requests to verify the user is of legal age for the gambling activity; in response to providing the one or more authorization requests, obtaining verification information associated with the user; and based on the verification information, providing, to the client computing device, authorization information indicating the age of the user is of the legal age to perform the gambling activity.

In some instances, the user data indicates a unique identifier for the user device, an email associated with the user, and/or at least a portion of a phone number associated with the user.

In some examples, the one or more lists comprise a whitelist and a yellow list, wherein the whitelist is stored in a verified users database and the yellow list is stored in a pending verification database, wherein the whitelist indicates one or more first users that have been previously verified to be of the legal age to perform the gambling activity, and wherein the yellow list indicates one or more second users that are pending verification for performing the gambling activity.

A third aspect of the present disclosure provides a non-transitory computer-readable medium having processor-executable instructions stored thereon, wherein the processor-executable instructions, when executed by one or more processors, facilitate: receiving, from a client computing device via a user device, user data, wherein the user device is associated with a user and the client computing device is associated with a gambling activity; comparing the user data with one or more lists, wherein the one or more lists are stored in one or more databases associated with an age verification system; based on the comparison, providing one or more authorization requests to verify the user is of legal age for the gambling activity; in response to providing the one or more authorization requests, obtaining verification information associated with the user; and based on the verification information, providing, to the client computing device, authorization information indicating the age of the user is of the legal age to perform the gambling activity.

All examples and features mentioned herein may be combined in any technically possible way.

### BRIEF DESCRIPTION OF THE DRAWINGS

The subject technology will be described in even greater detail below based on the exemplary figures, but is not limited to the examples. All features described and/or illustrated herein can be used alone or combined in different combinations. The features and advantages of various examples will become apparent by reading the following detailed description with reference to the attached drawings which illustrate the following:

FIG. 1 is a simplified block diagram depicting an exemplary computing environment in accordance with one or more examples of the present application.

FIG. 2 is a simplified block diagram of one or more devices or systems within the exemplary environment of FIG. 1.

FIG. 3 is an exemplary block diagram of an age verification system in accordance with one or more examples of the present application.

FIG. 4 is an exemplary process for age verification using a unique identifier for a user device in accordance with one or more examples of the present application.

FIGS. 5A-5C show an exemplary event sequence for age verification using a unique identifier for a user device in accordance with one or more examples of the present application.

FIGS. 6-15B show exemplary processes for age verification using a unique identifier for a user device in accordance with one or more examples of the present application.

### DETAILED DESCRIPTION OF THE INVENTION

Examples of the presented application will now be described more fully hereinafter with reference to the accompanying FIGs., in which some, but not all, examples of the application are shown. Indeed, the application may be exemplified in different forms and should not be construed as limited to the examples set forth herein; rather, these examples are provided so that the application will satisfy applicable legal requirements. Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

Systems, methods, and computer program products are herein disclosed that provide for age verification using a unique identifier for a user device. For example, an age verification system may be used for age verification of one or more users (e.g., ensuring or verifying that the age of one or more customers is appropriate prior to distributing or selling products or services to the customer). By using the age verification system, the systems and methods described herein provide for numerous advantages. For example, among other advantages, the age verification system may create a protective environment, mitigating and/or preventing human error while guaranteeing integrity as well as offering consumer and business protection and operational efficiency. In addition, by using the age verification system, the user might not be forced to provide any of his or her personal details to any database or representative, while also becoming eligible to buy an age restricted product without leaving a privacy trace.

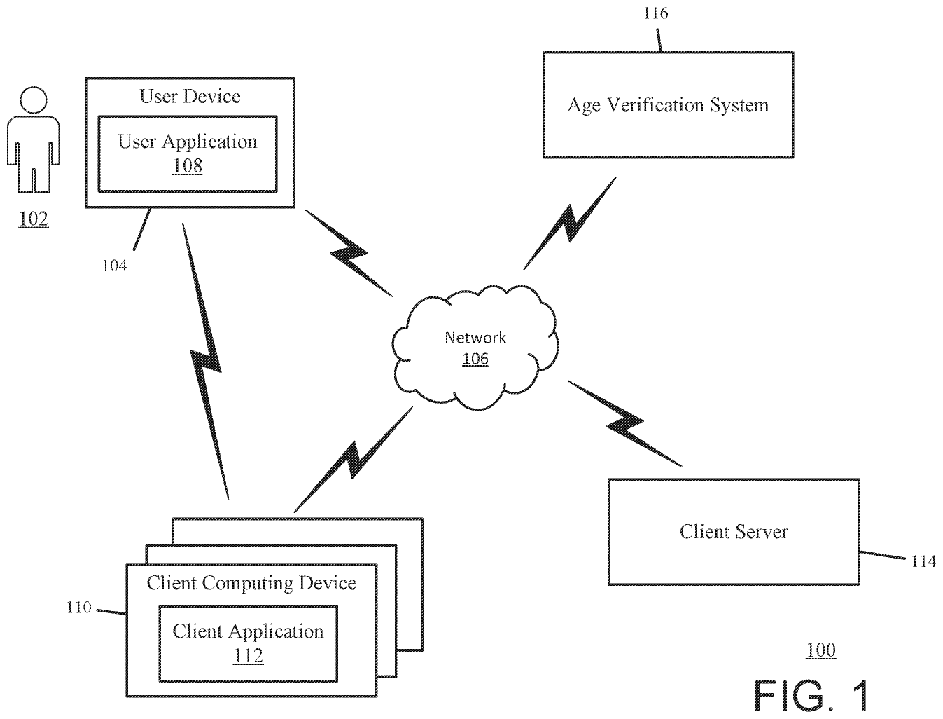

FIG. 1 is a simplified block diagram depicting an exemplary environment in accordance with an example of the present application. The environment 100 includes a user device 104, a network 106, one or more client computing devices 110, an age verification system 116, and a client server 114. The user device 104 may include and/or use a user application 108. The client computing device 110 may include client application 112. Although the entities within environment 100 may be described below and/or depicted in the FIGs, as being singular entities, it will be appreciated that the entities and functionalities discussed herein may be implemented by and/or include one or more entities. For instance, the age verification system 116 may include a plurality of computing devices, systems, platforms, and/or servers that are spread across multiple different geographical locations and communicate with each other using direct connections and/or the network 106.

The entities within the environment 100 such as the user device 104, the one or more client computing devices 110, the age verification system 116, and/or the client server 114 may be in communication with other systems or facilities within the environment 100 via the network 106. The network 106 may be a global area network (GAN) such as the Internet, a wide area network (WAN), a local area network (LAN), or any other type of network or combination of networks. The network 106 may provide a wireline, wireless, or a combination of wireline and wireless communication between the entities within the environment 100. In some instances, one or more entities within the environment 100 may communicate with each other without using the network 106 (e.g., via communication protocols such as WI-FI or BLUETOOTH or via wired connections). For instance, as shown, in some examples, the user device 104 may communicate with the client computing device 110 without using the network 106 (e.g., via communication protocols such as WI-FI, BLUETOOTH, near field communications (NFC), Internet of Things (IoT) technologies, or via wired connections). For example, the client computing device 110 may use a network beacon and/or a network device such as an internet of things (IoT) device to communicate with the user device 104. For instance, the user device 104 may provide information to the IoT device, and the IoT device may forward the information to the client computing device 110. Additionally, and/or alternatively, the client computing device 110 may provide information to the user device 104 via the IoT device.

User 102 may operate, own, and/or otherwise be associated with the user device 104. For instance, the user device 104 may perform one or more functions or tasks. For example, the user device 104 may include a user application 108 such as a software application and/or web application. The user application 108 may include instructions (e.g., executable code) that are stored in memory (e.g., memory of the user device 104). When executed by the user device 104, the instructions may facilitate performing age verification of the user 102. For instance, the user 102 may seek to engage in one or more age restricted activities such as gambling, alcohol, tobacco, and/or other age restricted services, and/or products. For example, the user 102 may seek to place a ticket for a gambling activity. Each location (e.g., each country) may have different rules such as age restrictions for performing the age restricted activity. For instance, in a certain country, users 102 under the age of 18 or 21 might not be allowed to perform or engage in the restricted activity such as placing a bet or purchasing alcohol. The user 102, using the user device 104 and the user application 108, may communicate with the age verification system 116 and/or the client computing devices 110 to validate and confirm that the user 102 is of legal age to partake in the activity. This will be described in further detail below.

The user device 104 is and/or includes, but is not limited to, a desktop, laptop, tablet, mobile device (e.g., smartphone device, or other mobile device), smart watch, an internet of things (IoT) device, or any other type of computing device that generally comprises one or more communication components, one or more processing components, and one or more memory components. The user device 104 may be able to execute one or more software applications and/or programs (e.g., the user application 108) owned, managed, serviced, and/or associated with an enterprise organization. The enterprise organization may be any type of corporation, company, organization, and/or other institution that provides one or more goods and/or services. For instance, the enterprise organization may be associated with the age verification system 116 and may perform age verification to ensure the use 102 is of legal age to perform one or more age restricted activities.

The environment 100 includes one or more client computing devices 110, and each client computing devices 110 may include and/or use a client application 112. For example, the client computing devices 110 may be associated with one or more clients that provide one or more age restricted activities. For instance, a first client computing device 110 may be associated with a client that provides a first restricted activity for the user 102 such as a gambling activity. A second client computing device 110 may be associated with a client that provides a second restricted activity for the user 102 that may be different from the first restricted activity. For example, the second restricted activity may be purchasing alcohol or tobacco. The client computing devices 110 may communicate with the user device 104 and/or the age verification system 116 to confirm that the user 102 is of legal age to perform the age restricted activity. For example, the client computing device may include a client application 112 such as a software application and/or web application. The client application 112 may include instructions (e.g., executable code) that are stored in memory (e.g., memory of the client computing device 110). When executed by the user device 104, the instructions may facilitate performing age verification of the user 102. This will be described in further detail below.

The client computing device 110 is and/or includes, but is not limited to, a desktop, laptop, tablet, mobile device (e.g., smartphone device, or other mobile device), smart watch, an internet of things (IoT) device, or any other type of computing device that generally comprises one or more communication components, one or more processing components, and one or more memory components. The client computing device 110 may be able to execute one or more software applications and/or programs (e.g., the client application 112) owned, managed, serviced, and/or associated with the enterprise organization.

The client server 114 is a computing system that is associated with one or more clients. For example, the client server 114 may be associated with one or more client computing devices 110. For instance, the client server 114 may store and/or manage information for one or more clients and/or client computing devices 110. In some instances, the client server 114 may store information associated with users 102. For example, the client server 114 may store historical information indicating when the users 102 previously performed or engaged in age restricted activities at their facilities. The historical information may be linked with one or more unique identifiers (ID) that are generated by and/or provided by the age verification system 116. In other words, when a user 102 performs an age restricted activity, the client server 114 may store information associated with the user 102 performing the age restricted activity. This will be explained in further detail below.

In some variations, the client server 114 may receive information from the age verification system 116 indicating the user's 102 performance of the age restricted activity. For instance, the age verification system 116 may generate and provide an identifier associated with the user 102 during the age verification process. The client server 114 may store this identifier from the age verification system 116. In some instances, the identifier may be randomly generated and/or generated in such a way to not indicate any personal information (e.g., the user's name, address, age, and/or other personal information) associated with the user 102. As such, the user's 102 personal information might not be known to the client (e.g., stored within the client server 114), but the client server 114 may still be able to determine whether the user 102 has previously engaged in the age restricted activity at their establishment based on the identifier from the age verification system.

The client server 114 includes and/or is implemented using one or more computing devices, computing platforms, cloud computing platforms, systems, servers, and/or other apparatuses capable of storing information associated with the user 102. In some variations, the client server 114 may be implemented as engines, software functions, and/or applications. In other words, the functionalities of the client server 114 may be implemented as software instructions stored in storage (e.g., memory) and executed by one or more processors.

The age verification system 116 is a computing system that is associated with the enterprise organization and performs age verification of the user 102. For example, the age verification system 116 may receive information from the user device 104 and/or the client computing device 110 such as document information, biometric information, and/or user device information. Based on the received information, the age verification system 116 performs age verification of the user 102 to ensure the user 102 is of legal age to perform the age restricted activity. For instance, the age verification system 116 may perform a document check and/or a biometric check to ensure the user 102 is of legal age. Based on performing the checks, the age verification system 116 may provide information to the user device 104 and/or the client computing devices 110. For instance, the age verification system 116 may provide information indicating that the user 102 is of legal age, and thus may perform the age restricted activity at the establishments owned or operated by the client. This will be described in further detail below.

The age verification system 116 includes and/or is implemented using one or more computing devices, computing platforms, cloud computing platforms, systems, servers, and/or other apparatuses capable of performing age verification for the user 102. In some variations, the age verification system 116 may be implemented as engines, software functions, and/or applications. In other words, the functionalities of the age verification system 116 may be implemented as software instructions stored in storage (e.g., memory) and executed by one or more processors.

It will be appreciated that the exemplary environment depicted in FIG. 1 is merely an example, and that the principles discussed herein may also be applicable to other situations—for example, including other types of institutions, organizations, devices, systems, and network configurations. For example, in some variations, the functionalities of the age verification system 116 may be separated into multiple different entities. For instance, the age verification system 116 may include a first system that performs a document check, a second system that performs a biometric check, and/or one or more data repositories (e.g., one or more verification databases such as a pending verification database and/or a verified users database) that stores information associated with the user 102.

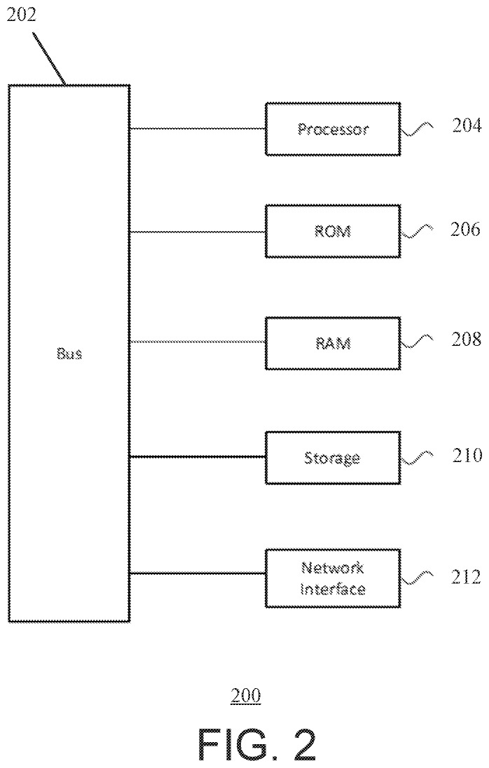

FIG. 2 is a block diagram of an exemplary system and/or device 200 (e.g., the user device 104, the client computing device 110, the client server 114, and/or the age verification system 116) within the environment 100. The device/system 200 includes one or more processors 204, such as one or more CPUs, controller, and/or logic, that executes computer executable instructions for performing the functions, processes, and/or methods described herein. In some examples, the computer executable instructions are locally stored and accessed from a non-transitory computer readable medium, such as storage 210, which may be a hard drive or flash drive. Read Only Memory (ROM) 206 includes computer executable instructions for initializing the processor 204, while the random-access memory (RAM) 208 is the main memory for loading and processing instructions executed by the processor 204. The network interface 212 may connect to a wired network or cellular network and to a local area network or wide area network, such as the network 106. The device/system 200 may also include a bus 202 that connects the processor 204, ROM 206, RAM 208, storage 210, and/or the network interface 212. The components within the device/system 200 may use the bus 202 to communicate with each other. The components within the device/system 200 are merely exemplary and might not be inclusive of every component, server, device, computing platform, and/or computing apparatus within the device/system 200. Additionally, and/or alternatively, the device/system 200 may further include components that might not be included within every entity of environment 100.

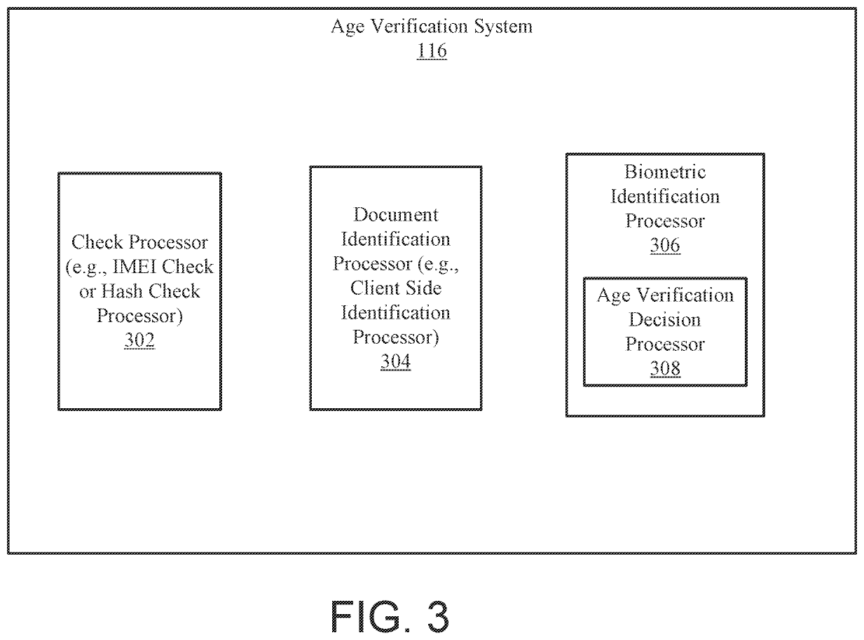

FIG. 3 is an exemplary block diagram of an age verification system in accordance with one or more examples of the present application. The age verification system 116 includes a check processor 302 (e.g., an international mobile equipment identity (IMEI) check or hash check processor), a document identification processor (e.g., a client side identification processor), and/or a biometric identification processor 306. The biometric identification processor 306 includes an age verification decision processor 308.

While the processors 302, 304, and/or 306 are shown as separate processors, and processor 308 is included within processor 306, in some examples, one or more of the processors may be combined together and/or the functionalities of the processors may be implemented by a combined processor and/or computing device. Additionally, and/or alternatively, one or more of the processors 302, 304, 306, and/or 308 may be separated into one or more additional processors. In some variations, the processors 302, 304, 306, and/or 308 and/or the entire age verification system 116 may be implemented as engines, software functions, and/or applications. In other words, the functionalities of the age verification system 116 and/or the processors 302, 304, 306, and/or 308, which are described below, might not be separate physical processors such as CPUs, and may be implemented as software instructions stored in a storage (e.g., memory) and executed by one or more processors, such as the storage 210 and processor(s) 204 in FIG. 2.

In some instances, the age verification system 116 (e.g., an age verification engine) performs an age verification process. The age verification system 116 may be applied in retail and/or online scenarios. For instance, the age verification system 116 may be used in an online service, such as a standalone mobile application and/or as a wrapper/API/SDK that is integrated into a client's system (e.g., the client computing devices 110 and/or the client server 114). By using the age verification system 116, this may enable the clients to have a degree of freedom on what kind and how much data they can request from their consumers and/or customers.

In some examples, by using the age verification system 116, the user 102 may perform age restricted activities (e.g., a gambling activity) while also staying completely anonymous. For instance, in order to ensure the optimal, risk free and operational efficient method of verifying the age of the user 102, the age verification system 116 utilizes a unique identifier associated with the user's 102 user device (e.g., the user device 104). For instance, in some variations, the unique identifier is a mobile phone identifier such as an IMEI number of the user device 104. Additionally, and/or alternatively, the unique identifier is another type of mobile phone identifier such as an ANDROID identifier (ID), an iPhone Operating System (iOS) unique device identifier (UDID), an advertising identifier (ID), and/or other types of unique identifiers that uniquely identify the user device 104.

In some instances, users 102 can decide to not provide any data besides their unique identifier and certain personal information during the age verification process. By using the user's unique identifier, the age verification system 116 is configured to securely store within one or more databases (e.g., one or more verification databases such as a data repository). For instance, the age verification system 116 may include and/or be associated with one or more databases that includes one or more lists such as a whitelist and/or a blacklist. The whitelist and/or the blacklist may indicate whether the user 102 has been previously verified. For instance, after verification of the user 102 (e.g., determining that the user 102 is of legal age to perform the age restricted activity), the age verification system 116 may move the user 102 from one of the lists to the other list. By moving the user 102, the age verification system 116 might not need to perform each step of the age verification process in the next iteration (e.g., in the next session when the user 102 seeks to perform an age verification process). For example, the age verification system 116 may store in the unique identifier of the user device 104 into the whitelist and/or the blacklist, which resides in one or more databases associated with the age verification system 116. Based on this, the age verification system 116 may perform appropriate responses and/or actions, and communicate with the user device 104 and/or the client computing device 110 to confirm the user 102 is of legal age for the age restricted activity.

For instance, the check processor 302 (e.g., the IMEI check processor) checks (e.g., determines in real-time) whether the specific user identifier of the user device 104 exists within the whitelist and/or the blacklist. For the user identifier to exist in the whitelist and/or the blacklist, the user 102 may have visited an authorized entity assigned by the client, who would ensure that the verification process was completed for the specific user device 104 and the user 102. For example, initially, the user 102 may belong to a first list. Based on the user 102 visiting an authorized entity (e.g., an establishment and/or facility that services age restricted activities), the client may verify that the user 102 is of an appropriate age. The age verification system 116 may move the user identifier associated with the user 102/the user device 104 from the first list to a second list. Based on the verification, the next time the user 102 visits an authorized entity (e.g., the same establishment or a different establishment associated with the client and/or a different client), the age verification system 116 may determine the user identifier is on the second list and might not need to perform each step of the age verification process. For instance, once the user 102 attempts to access any of the clients' services or products either in retail or online, the user 102 may simply be prompted to verify their identity (e.g., perform a biometric check to ensure the user 102 owns the user device 104). This will be explained in more detail below.

The check processor 302 performs one or more functions such as checking whether the user identifier obtained from the user device 104 and/or the client computing device 110 is included in the whitelist and/or the blacklist. The document identification processor 304 performs a document check. For example, the document identification processor 304 may provide information to the user device 104 and/or the client computing device 110, and receive information from the user device 104 and/or the client computing device 110. For instance, the document identification processor 304 may receive information from the client computing device 110 indicating whether the user's 102 ID is valid (e.g., the user's ID indicates the user 102 is of legal age to perform the age restricted activity). The biometric identification processor 306 may include the age verification decision processor 308. The processors 306 and/or 308 performs a biometric check. For instance, the processors 306 and/or 308 may provide and receive information from the user device 104. The information may indicate whether the user 102 owns or is authorized to use the user device 104. For instance, the user device 104 may include and/or use one or more biometric authorization processes such as face recognition, fingerprint recognition, voice recognition, and/or other types of biometric authorization processes. The user device 104 may perform the biometric authorization process to confirm that the user 102 owns and/or is authorized to use the user device 104. The user device 104 may provide information to the processors 306 and/or 308 indicating whether the user 102 owns and/or is authorized to use the user device 104.

For instance, in some variations, using the built-in biometric functions of the user device 104, the biometric identification processor 306 may obtain information indicating the result of the biometric function performed by the user device 104. After completing the age verification process, the user 102 might not ever need to complete the verification process with the authorized entity again as their unique identifier from their user device 104 is now linked with their biometric secure and encrypted information using the biometric identification processor 306.

In some variations, the unique identifier of the user device 104 and the “verified user 102 may be removed from one or more lists in the case where the user application 108 is no longer accessible and essentially unlinked from the user's user device 104. This ensures that the age verification system 116 covers all the basic cases related to the user device 104 such as in cases of theft, loss, application deletion, factory reset, and many more.

In some variations, the age verification process is performed using the age verification system 116 and/or the processors 302, 304, 306, and/or 308. For instance, by using the age verification system 116, the overall age verification process may be simplified for both the user 102 as well as the client (e.g., the client associated with the client computing device 110 and/or the client server 114). This may be performed by utilizing the user device's 104 unique identifier (e.g., IMEI number) and/or other information associated with the user 102 such as, but not limited to, the user's phone number and/or email, along with the additional processors 302, 304, and/or 306, which work with the age verification decision processor 308 to provide the decision of whether the user 102 is eligible to perform the age restricted activity (e.g., purchase an age restricted product and/or service based on the limitations configured by the client and/or associated with a location such as a geographical or territorial location). In order to provide an easy way of distinguishing eligible from ineligible users (e.g., whether the user 102 is of legal age), the age verification system 116 (e.g., the check processor 302) may check and update the status of the specific unique identifier number associated with the respective user 102 and move the unique identifier into a whitelist or a blacklist (e.g., into a pending verification database and/or a verified users database).

In some instances, the age verification process may begin when the user 102 uses a user application (e.g., user application 108) on their user device 104. The user device 104 may utilize built-in and/or external IoT technologies such as near field communications (NFC), beacons, BLUETOOTH, and/or other communication protocols and/or devices to provide information to a client computing device 110. The client computing device 110 may execute an application such as a client application 112, and provide information to the age verification system 116. For instance, the user device 104 may provide its unique identifier (e.g., unique IMEI number) to the age verification system 116 via the client computing device 110 to begin the age verification process. This process might not require the user device 104 to transmit any data through the network 106. In other words, the user device 104 may provide a unique identifier (e.g., IMEI number) associated with the user device 104 to the client computing device 110 using one or more communication protocols and/or devices (e.g., a beacon and/or IoT device). The client computing device 110 may forward the received unique identifier to the age verification system 116.

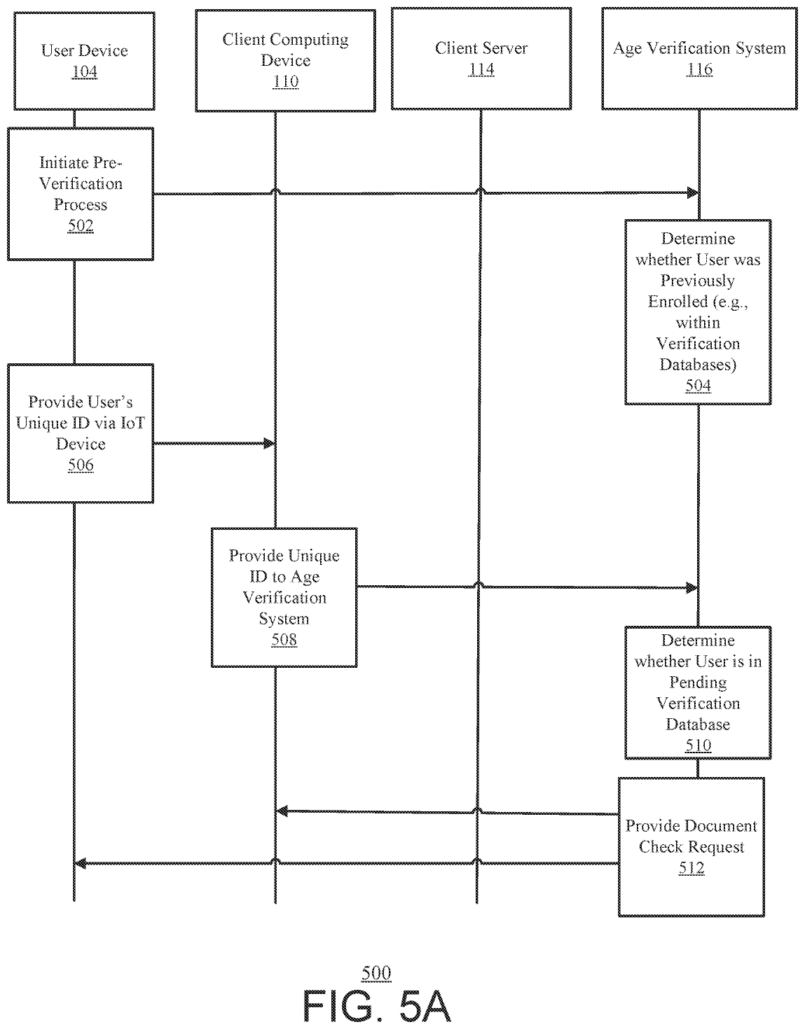

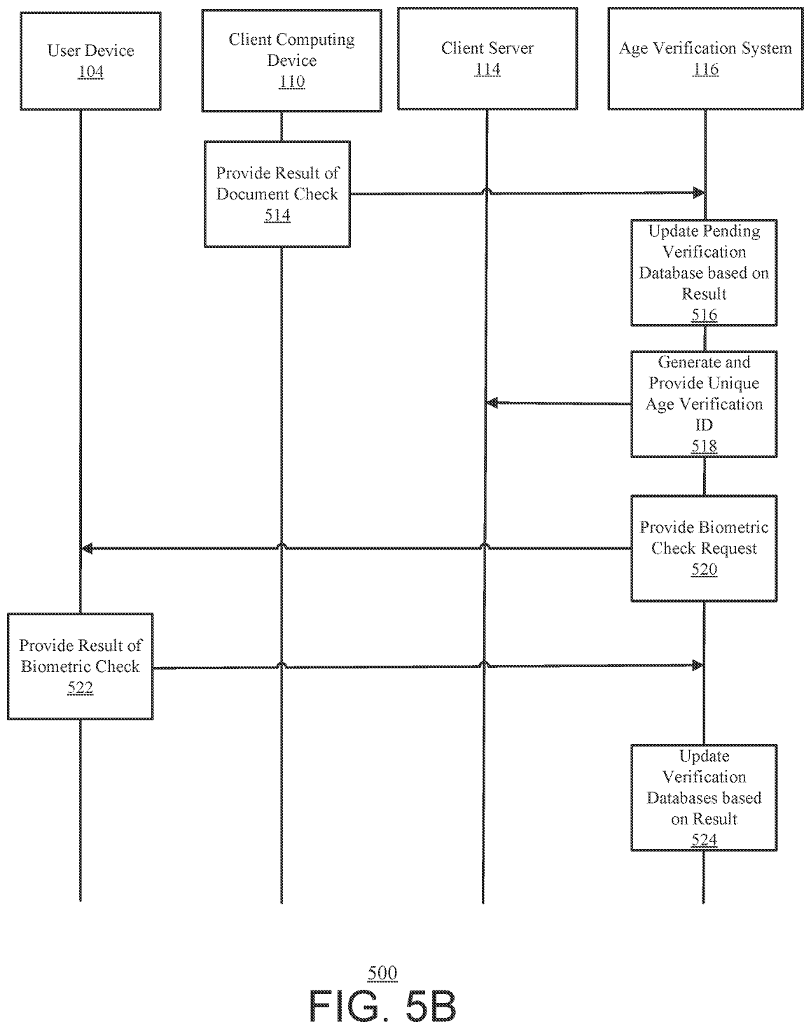

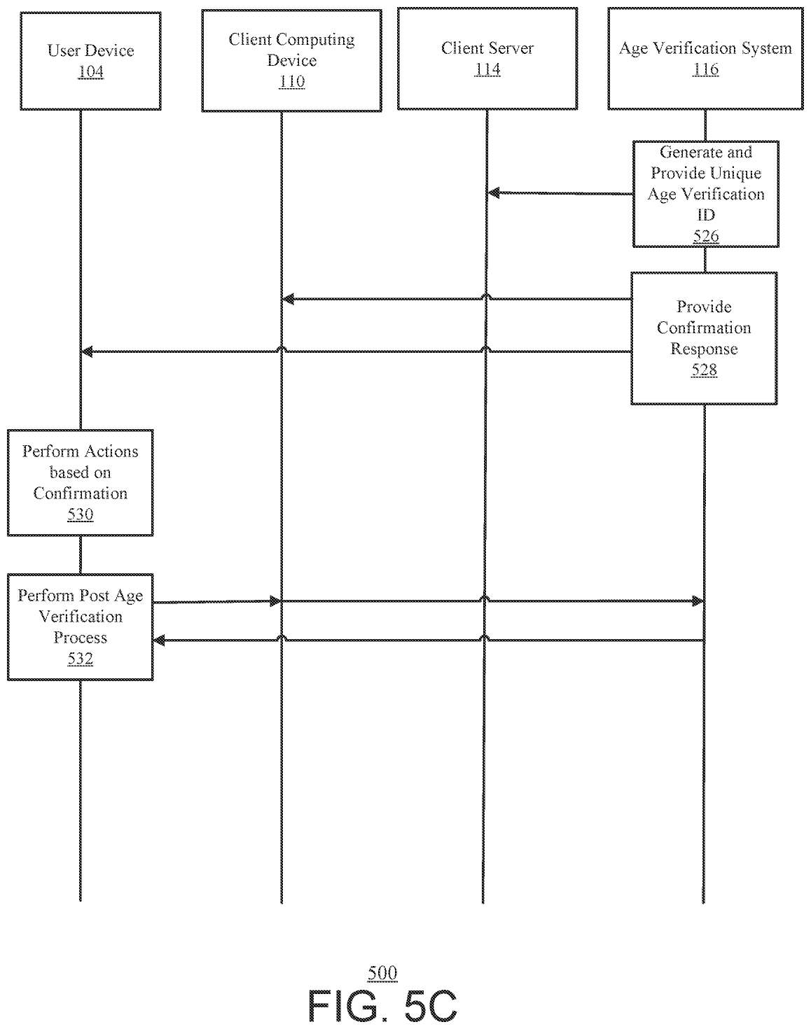

In some instances, as will be explained in FIG. 5A below, the age verification process may include a pre-verification process. For instance, the user 102 may download the user application 108 on the user device 104 and perform one or more functions with the age verification system 116.

In some examples, the client computing device 110 (e.g., the authorized entity's compatible verification system), may have already loaded the necessary information and data that may be required for the age verification process from the respective client's server 114 through the secure network 106. These may include data such as the address of the entity, unique identifiers, timestamps, and many more. This information may be used to identify who gave access to the user 102 (e.g., the customer) and validated the customer's ID, in order to avoid fraudulent acts. This may also enable the clients to have a complete view of which authorized entity completed each verification process using the age verification system. All of this information is securely transmitted through the secure network 106, back to the client application 112 and client computing device 110.

Following the unique identifier transmission process from the user device 104 to the client computing device 110 (e.g., transmitting the unique identifier to the client computing device 110 via a beacon and/or IoT), the client application 112 receives the unique identifier of the user device 104 and distributes through the secure network 106, along with the required information provided from the client's server 114 through a respective application (e.g., an application executing on the client's server 114), through the network 106, to the age verification system 116. The check processor 302 of the age verification system 116 may process this information (e.g., the unique identifier). For example, the client application 112 may provide a pop-up message requesting the client to provide user input indicating whether the user 102 is of legal age (e.g., 18 years of age or 21 years of age depending on jurisdiction). Based on the user 102 being of age, user input may be provided to the client application 112 indicating that the user 102 is legal age and the response may be sent to the age verification system 116 with additional information. The additional information may include, but is not limited to, the client's address (e.g., the address associated with the client and/or the client computing device 110), one or more unique identifiers, timestamps, and/or other information.

After, the age verification system 116 may provide a response indicating whether the given unique identifier is on one or more lists such as a whitelist and/or a blacklist. For instance, the age verification system 116, which may use and/or execute an application residing on a cloud platform, may provide a response indicating whether the unique identifier exists in a database (e.g., a cloud database). For example, the check processor 302 may determine whether the unique identifier (e.g., the given IMEI) exists in the cloud database by comparing the unique identifier with one or more lists (e.g., the whitelist and/or the blacklist). For instance, in some variations, the whitelist may indicate user identifiers that have already undergone the age verification process, and have already been verified as age appropriate for the age restricted activity. The blacklist may indicate that the unique identifier has been indicated as ineligible to purchase the product or service from the client. In some variations, a third list (e.g., a yellow list) may also be included, which indicates that the unique identifier of the user device 104 has not been verified at this time.

In some instances, the lists may be stored in the same database (e.g., a verification database). In other instances, one or more of the lists may be stored in a different database. For example, the whitelist may be stored in a first database such as a verified users database. The yellow list may be stored in a second database such as a pending verification database. The age verification system 116 may move unique identifiers from the yellow list (e.g., pending verification database) to the whitelist (e.g., the verified users database) based on performing the age verification process. For instance, initially, the check processor 302 may check whether the unique identifier of the user device 104 provided by the client computing device 110 exists in one or more of the lists (e.g., the whitelist and/or the yellow list).

In the event that the unique identifier of the user device 104 exists in the whitelist, then the age verification system 116 may return the appropriate message response through the secure network 106, to both the client computing device 110 as well as in the user device 104. This response may trigger the activation function in the client computing device 110 in order to unlock the next stage of the verification process (e.g., a biometric verification process).

However, if the unique identifier of the user device 104 exists in the blacklist, then the age verification system 116 may return the appropriate message response through their secure network 106, to both the client computing device 110 as well as in the user device 104. This may indicate that the specific unique identifier has already been blacklisted as ineligible to purchase the product or service from the client.

Further, in the case where the unique identifier of the user device 104 does not exist on the whitelist nor the blacklist, this means that the process might not have been completed before and/or that the process of the verification may need to be completed again. For example, based on the unique identifier being on the yellow list, this may prompt the age verification system 116 to perform the age verification process such as the document check process and/or the biometric check process. As a result, the age verification system 116 may return the appropriate message response through their secure network 106, to both the client computing device 110 as well as in the user device 104 and/or perform the proper verification processes. In other words, this may trigger the in-person verification process for both sides, which may be satisfied and/or performed by the document identification processor 304, which resides on the age verification system 116 through an application layer.

During the in-person verification process (e.g., the document check process), based on the response, the user 102 may be prompted on his/her screen (e.g., the screen of the user device 104) through the user application 108 to provide an ID authentication document (e.g., a driver's license, passport, government ID document, and/or other document that verifies the age of the user 102) to an authorized entity for further examination. In other words, in some examples, the ID authentication document might not be stored in any system such as the client server 114 and/or the age verification system 116. For instance, the client computing device 110 may prompt a response (e.g., “yes” or “no”) to indicate whether the user 102 is of age.

For instance, the authorized entity may be assigned by the client, and may be prompted via the client application 112 on the client computing device 110 with a message to carefully examine the user's verification document (e.g., the ID authentication document) to ensure that the user 102 in front of them is eligible of performing the age restricted activity (e.g., buying the specific product or service). The authorized entity may select the appropriate response that appears on the client computing device 110 indicating whether the user 102 is eligible. The authorized entity may be an operator, person, employee, manager, and/or any other individual associated with the client that has authority to confirm whether the user 102 is of legal age.

In other words, the age verification system 116 provides prompts to the user device 104 and the client computing device 110. Based on the prompts, the user 102 may show their ID authentication document to the authorized entity. The client computing device 110 may receive input from the authorized entity based on whether the user 102 is of legal age, and may provide information (e.g., a result of the document check request) to the age verification system 116. For instance, this process triggers the next step in the verification process, which involves transmitting the authorized entity's response through the secure network 106 back to the age verification system 116 to be further processed by the document identification processor 304.

Based on the authorized entity's decision, which was transmitted to the document identification processor 304, a new response may be generated by the age verification system 116 to trigger the next stage of the verification process. This process involves verifying the identity of the user 102 holding the user device 104 as well as to avoid fraudulent acts through the use of the biometric identification processor 306.

The document identification processor 304 may provide one or more different responses through the network 106 back to the user application 108 of the user device 104 and/or the client application 112 of the client computing device 110. The response may also be transmitted into and/or provided to the age verification decision processor 308, which may take appropriate actions based on the contents of the response. For instance, the age verification decision processor 308 may move the unique identifier of the user device 104 into one or more lists (e.g., the whitelist or the blacklist) to link and indicate whether the user 102 of the user device 104 is eligible for performing the age-restricted activity.

For instance, if the response of the document identification processor 304 is negative, this means that the user 102 is not eligible for the age-restricted activity. If the unique identifier was already on the whitelist, then the age verification system 116 (e.g., the processor 308) may move the unique identifier from the whitelist to the blacklist. If the unique identifier does not exist on either the whitelist or the blacklist (e.g., not in any database and/or on the yellow list), the age verification system 116 may generate a new record on the blacklist that marks the unique identifier as ineligible for the age restricted activity. Additionally, and/or alternatively, the response provided by the age verification system 116 through the network 106 may be displayed on the user application 108 of the user device 104 and/or the client application 112 of the client computing device 110. The response may indicate that the user 102 is not of the legal age to perform the age restricted activity (e.g., make the purchase and/or use the service or product), and the process may terminate while having successfully blacklisted the user's unique identifier of the user device 104 until the next age verification process occurs.

If the response that the document identification processor 304 returns is positive, it means that the user is eligible to perform the age restricted activity (e.g., buy the specified product or service based on the configurations set by the client), and the next step of the verification process may be triggered on the user device 104. The next step may be to perform the biometric verification process.

For instance, this next step (e.g., the biometric verification process) may be crucial in ensuring that the user 102 of the user application 108 and of the user device 104 is the same person that completed the document check and is attempting to make the purchase or use the specified service. In order to achieve this, the biometric identification processor 306, which resides on the age verification system 116 is used.

The result of the biometric identification process that is completed by the user 102 is distributed back to the age verification system 116 through the secure network 106 in order to be processed by the biometric identification processor 306. In the end, the age verification system 116 retrieves the response from the biometric identification processor 306. If the response is positive and the biometrics match, then the linked user's device unique identifier is added onto the whitelist along with all the required information (e.g., the Client ID, location, date and time, and/or other information).

Finally, the age verification system 116 sends out a confirmation response through the secure network 106, back to both the user application 108 as well as the client application 112. This triggers built-in functions, which displays the appropriate message ensuring that the process has been completed and that the user 102 of the specific user device 104 has been verified and may only need to pass the biometric verification process while engaging in future age restricted activities (e.g., completing future purchases).

In other words, by whitelisting the specified unique identifier of the user device 104 (e.g., the IMEI number), the age verification system 116 ensures that the user 102 of the user device 104 has been age verified and is now eligible to perform the age restricted activities (e.g., buy age restricted products and/or use services from the client with the user device 104) by only providing the user's 102 biometrics through the user device 104 and/or via similar means.

In the case where the response from the biometric identification is negative, both the user 102 as well as the authorized entity may receive the appropriate response (e.g., using the user device 104 and the client computing device 110) that the user has failed the biometric authentication and may either try again and/or stop the process. Additionally, and/or alternatively, the age verification system 116 may move the unique identifier of the user device 104 to another list (e.g., from the whitelist to the blacklist) and/or remove the unique identifier from the whitelist.

In other words, the next time that a verified user 102 attempts to make a purchase or use an age-restricted service, the user 102 may simply need to complete the biometric identification step, which may confirm that the user 102, which initially passed the document check is the same person that is attempting to make the purchase with the same user device 104 that was used to verify the identity of the user 102 with the help of the authorized entity assigned by the client. This will be described in further detail below.

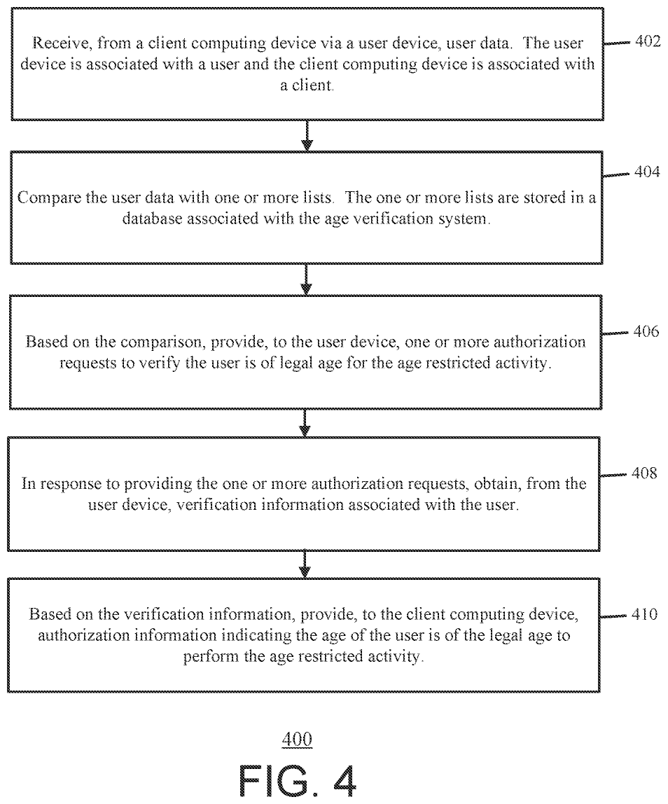

FIG. 4 is an exemplary process for age verification using a unique identifier for a user device in accordance with one or more examples of the present application. The process 400 may be performed by the age verification system 116 shown in FIGS. 1 and/or 3. It will be recognized that any of the following blocks may be performed in any suitable order, and that the process 400 may be performed in any suitable environment. The descriptions, illustrations, and processes of FIG. 4 are merely exemplary and the process 400 may use other descriptions, illustrations, and processes for age verification using a unique identifier for a user device.

In operation, at block 402, the age verification system 116 receives from a client computing device 110 via a user device 104, user data. The user data may indicate and/or include a unique identifier for the user device 104 and/or other user information such as the email address and/or phone number of the user 102. The user device 104 is associated with a user 102 and the client computing device 110 is associated with a client. For example, as mentioned above, the user device 104 may include and/or be associated with a unique identifier such as an IMEI number, an ANDROID ID, an iOS UDID, an advertising ID, and/or other types of unique identifiers that uniquely identify the user device 104. The user device 104 may provide the user data such as user device information indicating the unique identifier to the age verification system 116 via the client computing device 110. For example, using one or more communication protocols and/or devices (e.g., an IoT device and/or beacon), the user device 104 may provide the user device information to the client computing device 110. The client computing device 110 may provide the receive user device information to the age verification system 116. In some variations, the client computing device 110 may receive information from the client server 114 and include information from the client server 114 into the user device information that is then provided to the age verification system 116. In other words, the age verification system 116 may receive user device information that indicates the unique identifier for the user device 104 and/or additional information from the client server 114.

In some examples, the user device 104 may provide user information such as the email address and/or the phone number of the user 102. In other words, the user device 104 may provide the unique identifier of the user device 104, the email address of the user 102, the phone number of the user 102, and/or other information associated with the user 102. In some instances, the user device 104 might not provide any additional personal and/or sensitive information of the user 102 to the age verification system 116 and/or another other entity in the environment 100. For instance, by providing only the user information and/or the unique identifier, the process (e.g., process 400 and/or event sequence 500) can ensure the user 102 is of legal age to purchase the product/services while keeping the user 102 completely anonymous. In other words, the age verification system 116, the client computing device 110, and the client server 114 might not collect and/or be able to collect any kind of personal and/or sensitive data of the user 102.

At block 404, the age verification system 116 compares the data (e.g., the unique identifier for the user device 104 and/or the user information) with one or more lists. The one or more lists are stored in a database associated with the age verification system 116 (e.g., the age verification system 116 may include one or more databases and/or the age verification system 116 may manage one or more lists within an external database).

For instance, as mentioned above, the age verification system 116 may include one or more lists such as a whitelist, a blacklist, and/or a yellow list. The whitelist may indicate users that have already undergone and successfully completed the age verification process (e.g., the user 102 previously passed both the document check and the biometric verification check). The blacklist may indicate users that have already undergone and failed the age verification process (e.g., the user 102 previously failed either or both the document check and the biometric verification check). The yellow list may indicate users that have not gone through the age verification process previously. For instance, initially, the unique identifier might not be part of the blacklist or the whitelist (e.g., may be included as part of the yellow list during a pre-verification process, which is described in block 502 of FIG. 5A). The age verification system 116 may compare the unique identifier with identifiers from one or more lists. In other words, the whitelist indicates one or more first users that have been previously verified to be of the legal age to perform an activity (e.g., a gambling activity) and the yellow list indicates one or more second users that are pending verification for performing the activity (e.g., not yet verified as to whether they can perform the gambling activity).

Based on the comparison, the age verification system 116 may perform one or more actions. For example, if the user identifier of the user device 104 is on the white list, the age verification system 116 may skip one or more verification processes (e.g., the document verification process) and perform the next verification process (e.g., the biometric verification process). If the user identifier is on the black list, the age verification system 116 may stop the verification process and provide a notification indicating that the user identifier has previously undergone the verification process and has failed the verification process. Additionally, and/or alternatively, even if the user identifier is on the black list, the age verification system 116 may perform one or more verification processes (e.g., the document verification process and/or the biometric verification process). For instance, in the previous instance when the user 102 failed, the user 102 might not be of age (e.g., 17 years of age) for the age restricted activity. Since then, the user 102 may be of age (e.g., turned 18 years old), and thus, the age verification system 116 may perform one or more verification processes to confirm that the user 102 is of age to perform the age restricted activity.

If the user identifier is on the yellow list, the age verification system 116 may perform one or more authorization requests to verify the user 102 is of legal age for the age restricted activity (e.g., the gambling activity). Blocks 406-410 describe the age verification system 116 performing the authorization requests (e.g., performing the verification processes such as the document verification process and/or the biometric verification process).

At block 406, based on the comparison, the age verification system 116 provides one or more authorization requests to verify the user 102 is of legal age for the age restricted activity (e.g., the gambling activity). At block 408, in response to provide the one or more authorization requests, the age verification system 116 obtains, from the user device 104, verification information associated with the user 102.

For example, based on the comparison and determining that the user identifier of the user device 104 is not on either of the whitelist nor the blacklist (e.g., on the yellow list), the age verification system 116 performs one or more verification processes such as a document verification process and/or a biometric verification process. For instance, first, the age verification system 116 may perform the document verification process. The age verification system 116 may provide an authorization request to the user device 104 and/or the client computing device 110, which may display a prompt indicating for the user 102 to show their ID authentication document (e.g., a driver's license, passport, government ID document, and/or other document that verifies the age of the user 102) to an authorized entity for further examination. For instance, based on the authorization request from the age verification system 116, the user device 104 and/or the client computing device 110 may display a prompt indicating for the user 102 to display their ID authentication document such as a driver's license or passport to the authorized entity such as an employee that is employed by the client.

Afterwards, the client computing device 110 may display a prompt indicating for the authorized entity to select whether the user's ID authentication document indicates that the user 102 is of legal age for performing the age restricted activity (e.g., the user 102 is 21 and able to purchase alcohol). Based on input from the authorized entity, the client computing device 110 may provide information to the age verification system 116 indicating that the user 102 is of legal age. The age verification system 116 may perform one or more actions such as updating the list (e.g., the yellow list) to indicate that the user 102 has passed the document verification process and/or initiate the biometric verification process. In some instances, the client computing device 110 may provide information indicating that the user 102 is not of legal age. The age verification system 116 may perform one or more actions such as updating the list to indicate that the user 102 did not pass the document verification process, remove the user identifier from the whitelist, and/or generate an entry on the blacklist indicating the user identifier.

If the user 102 has passed the document verification process, the age verification system 116 may further provide an authorization request to the user device 104 for the user 102 to perform the biometric verification process. For example, using a biometric process such as facial recognition, fingerprint recognition, voice recognition, and/or any other type of biometric process, the user device 104 may confirm whether the user 102 owns and/or is authorized to use the user device 104. For instance, the user device 104 may use a feature from the user device 104 (e.g., a camera or voice recorder of the user device 104) and/or an external device (e.g., an external camera or voice recorder) to perform the biometric process. For example, the user device 104 may perform the biometric process (e.g., confirm that the user's facial scan matches the previous facial scan to unlock the user device 104) and provide the results of the biometric process back to the age verification system 116.

The age verification system 116 may receive the results from the biometric process such as an indication indicating that the user 102 passed the biometric process or failed the biometric process. Based on the user 102 passing the biometric process, the age verification system 116 may perform one or more actions such as updating the list (e.g., the yellow list) to indicate that the user 102 has passed the document verification process, move the user identifier to another list (e.g., the white list), and/or provide authorization information to the user device 104 and/or the client device 110 indicating that the user 102 has passed both verification processes and is of legal age to perform the age restricted activity. In some instances, the user device 104 may provide information indicating that the user 102 did not pass the biometric process. The age verification system 116 may perform one or more actions such as updating the list to indicate that the user 102 did not pass the biometric verification process, remove the user identifier from the whitelist, and/or generate an entry on the blacklist indicating the user identifier.

In other words, at block 406, the age verification system 116 may provide one or more authorization requests (e.g., a document verification request for the authorized entity to check the ID of the user 102 and/or a biometric verification request for the user 102 to confirm that he/she owns and/or is authorized to use the user device 104). At block 408, the age verification system 116 may obtain verification information associated with the user 102 (e.g., indicating the user 102 passed the biometric verification request).

In some instances, based on the comparison, the age verification system 116 may determine the user identifier is on the whitelist. Based on this determination, the age verification system 116 may skip one or more verification processes (e.g., the document verification process) and proceed to another verification process (e.g., the biometric verification request). For instance, the age verification system 116 and the user device 104 may perform the biometric verification process. Based on the result, the age verification system 116 may perform one or more actions that are described above. For instance, if the user 102 passed (e.g., based on determining the user being on the whitelist and the biometric verification information indicating that the user passed the biometric process performed by the user device), the age verification system 116 may provide authorization information indicating that the age of the user 102 is of legal age to perform the age restricted activity. If the user 102 failed, the age verification system 116 may remove the user identifier from the whitelist and/or generate an entry on the blacklist indicating the user identifier.

In other words, at block 406, based on the user identifier being on the whitelist, the age verification system 116 may provide an authorization request (e.g., biometric request) to verify the user 102 is of legal age for the age restricted activity (e.g., the user 102 has previously verified themselves and is the owner and/or is authorized to use the user device 104). At block 408, the age verification system 116 may obtain from the user device 104 the verification information indicating that the user 102 passed or failed the biometric check.

At block 410, based on the verification information, the age verification system 116 provides, to the client computing device 110, authorization information indicating the age of the user 102 is of the legal age to perform the age restricted activity (e.g., the gambling activity). For instance, the age verification system 116 provides authorization information, which may prompt the client computing device 110 to display an indication that the user 102 is of legal age to perform the age restricted activity. Based on this, the user 102 may be allowed to perform the age restricted activity at the client's facility and/or establishment. For example, the user 102 may be allowed to gamble, buy alcohol, buy tobacco, and/or perform other age restricted activities.

In some instances, the age verification system 116 may communicate with the client server 114. For example, the age verification system 116 may generate and/or provide one or more user identifiers to the client server 114. For instance, the age verification system 116 may obtain (e.g., generate and/or provide) one or more unique identifiers for the user 102 based on the verification information associated with the user, and provide the unique identifiers to the client server 114. The verification information may comprise document verification information indicating that the user passed a document identification check process and biometric verification information indicating that the user passed a biometric verification process. For instance, the unique identifiers (e.g., the user identifiers) may be associated with the user 102 and/or the unique identifier of the user device 104. For instance, instead of providing the user identifier of the user device 104 and/or other personal information of the user 102 to the client server 114, the age verification system 116 may generate a user identifier (e.g., using a random generated process) and provide the user identifier to the client server 114. In some examples, the client server 114 may provide historical information associated with the user 102. For instance, using the user identifier that was previously generated for the user 102, the client server 114 may store historical data indicating gambling activities and/or other activities of the user 102. By using the user identifier, the client might not know or recognize who the user 102 is as they only know the user 102 through the user identifier. But, the client may know previous activities associated with the user identifier. The client server 114 may provide the historical data associated with the user identifier, and the age verification system 116 may determine information based on the historical data. For instance, the age verification system 116 may determine one or more offers and/or promotional offers for the user 102 based on the historical data. For instance, the user 102 may have previously gambled at the client's establishment or at a different client's establishment. As such, the age verification system 116, using the user identifier provided by the client server 114 and the historical data, may determine one or more promotional offers. At block 410, the age verification system 116 may generate and provide authorization information to the user device 104 and/or the client computing device 110. The authorization information may indicate that the user 102 is of legal age to perform the age restricted activity and may include the determined promotional offers.

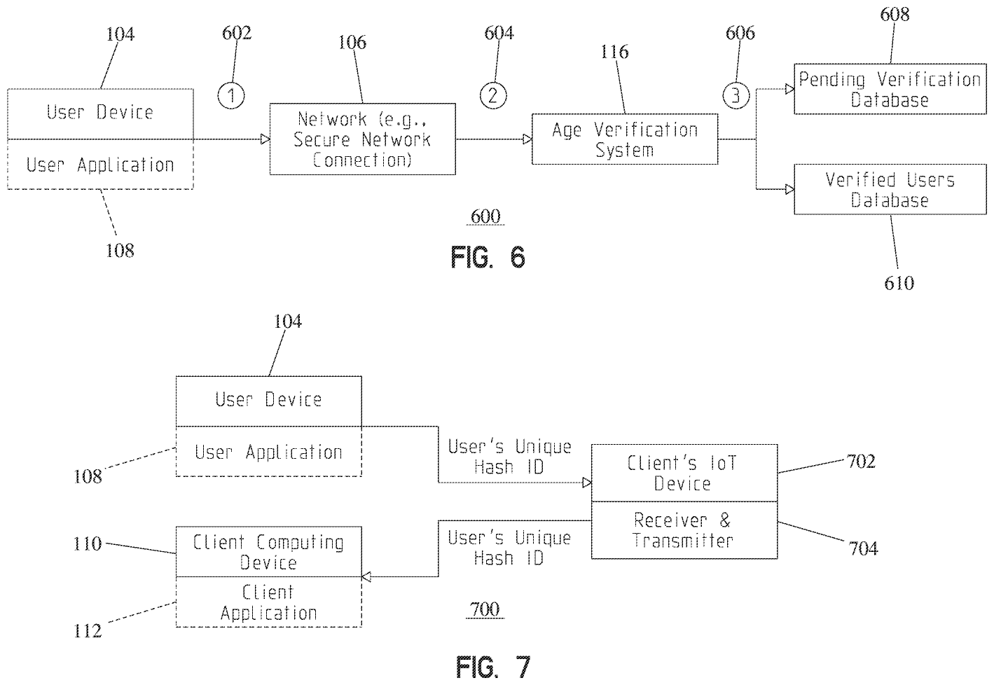

FIGS. 5A-5C show an exemplary event sequence for age verification using a unique identifier for a user device in accordance with one or more examples of the present application. However, the event sequence 500 is merely an example and other types of event sequences are contemplated herein including by performing any of the following blocks in any suitable order. For instance, the event sequence 500 describes process 400 in more detail. The event sequence 500 will be described with reference to processes 600-1500 of FIGS. 6-15B.

In operation, at block 502, the user device 104 initiates the pre-verification process. For example, the user 102 may download an application (e.g., a software application and/or web application) on the user device 104, which initiates the pre-verification process. The application may be the user application 108 shown in FIG. 1. The user device 104 may communicate with the age verification system 116 to initiate the pre-verification process. For instance, at block 504, the age verification system 116 may determine whether the user 102 was previously enrolled (e.g., within one or more verification databases such as a pending verification database and/or a verified users database). For example, the age verification system 116 may store one or more lists (e.g., a whitelist, a blacklist, and/or a yellow list) into one or more verification databases. For instance, the whitelist may be stored in a verified users database and the yellow list may be stored in the pending verification database. Initially, at blocks 502-504, during the pre-verification process, the user device 104 may provide device information (e.g., a unique identifier associated with the user device 104) to the age verification system 116. The age verification system 116 may check to determine whether the unique identifier is on one or more of the lists such as the whitelist (e.g., stored in the verified users database) or the yellow list (e.g., stored in the pending verification database). If the age verification system 116 determines that the unique identifier is not on one of the lists (e.g., the whitelist), then the age verification system 116 may generate an entry for the unique identifier of the user device 104 and include the entry within the yellow list (e.g., stored in the pending verification database). If the age verification system 116 determines that the unique identifier is stored on one or more of the lists, the age verification system 116 might not generate the entry for the unique identifier and include the entry within the yellow list.

In other words, at blocks 502-504, the user device 104 and the age verification system 116 may determine whether the user 102 has already been previously enrolled and determined to be of legal age for performing the age restricted activity (e.g., gambling). For instance, the age verification system 116 may store lists on one or more databases to indicate whether the user 102 has already been determined to be of legal age (and/or determined to not be of legal age by checking the blacklist). For example, the whitelist may indicate user identifiers associated with users 102 and/or user devices 104 that have already been previously verified to be of legal age. The user device 104 may provide enrollment information (e.g., a first hashed value of a unique identifier associated with the user device and one or more second hashed values indicating a phone number or email address associated with the user) to the age verification system 116. At block 504, if the unique identifier provided by the user device 104 is not on the whitelist (e.g., the user 102 just downloaded the application and has not been determined to be of legal age previously), the age verification system 116 may generate an entry for the unique identifier and include the entry on the yellow list (e.g., store the entry in the pending verification database). For instance, based on comparing the enrollment information with the one or more lists, the age verification system 116 may generate an entry (e.g., an entry indicating the enrollment information) and include the entry on the one or more lists for the user 102. In some instances, the entry may include the unique identifier. In other instances, the entry may include additional metadata such as a first indication of whether the unique identifier has passed a document check process, a second indication of whether the unique identifier has passed a biometric check process, and/or other metadata (e.g., metadata associated with the unique identifier, user 102, and/or the user device 104).

FIG. 6 describes blocks 502 and 504 in more detail. For instance, FIG. 6 shows the user device 104 with the user application 108, the network 106 (e.g., the secure network connection), the age verification system 116, the pending verification database 608 (e.g., the database that stores the yellow list), and the verified users database 610 (e.g., the database that stores the whitelist). FIG. 6 also shows three steps 602-606 of the pre-verification process. For example, when the user 102 first downloads, installs, and/or launches the user application 108 on their user device 104, the client could initiate multiple methods for their users 102 based on the available functions provided by the SDK/AI of the age verification process.

For instance, in a first scenario that includes complete anonymity of the user's data, the user application 108 (e.g., the user device 104) may hash the unique identifier of the user device 104 (e.g., the IMEI, ANDROID ID, iOS UDID, Advertising ID). The user device 104 may then provide the hashed unique identifier to the age verification system 116 via the network 106. In some instances, the user device 104 may use a hashing algorithm to hash the unique identifier such as a one-way hashing algorithm (e.g., a secure hash algorithm (SHA)-256).

In a second scenario, a short semi-registration process that includes the user 102 providing some type of information through their installed user application 108 is used. For instance, the user 102, using the user device 104, may input information such as the phone number of the user device 104, the email address of the user 102, and/or other types of information associated with the user 102 and/or the user device 104. Additionally, and/or alternatively, the user application 108 may prompt the user 102 for two factor authentication (or any other verification method) that sends a unique one time passcode to the user device 104 and/or the email address of the user 102 respectively (or any other means that belong to the user 102) in order to confirm that the specified information belonging to the specific user 102 is correct. Based on performing the two-factor authentication or other verification method, the process proceeds to the next step. Afterwards, for the semi-registration process, the user application 108 (e.g., the user device 104) encrypts the data that the user 102 provided to the user application 108 (e.g., the input information such as the phone number or email address). The encryption may use transport layer security (TLS)/secure sockets layer (SSL) to prevent eavesdropping and/or man-in-the-middle attacks while transmitting the data to the age verification system 116 (e.g., directly to the system 116 and/or via the client computing devices 110 and/or intermediate devices such as IoT devices).

For the second scenario, in some variations, the user device 104 may further have the unique identifier for the user device 104. Further, in both scenarios described above, in order to protect the user's data, the user device 104, executing the user application 108, generates the user unique hash identifier using the same one-way hashing algorithm. In other words, the user device 104 generates a hashed unique identifier for the user device 104 and a user unique hash identifier associated with the user 102, and provides them to the age verification system 116.

In some instances, the user device 104 generates the user unique hash identifier, which may be associated with the hashed and/or encrypted values of the user's information (e.g., the user's email address or phone number). By using the user unique hash identifier, this allows the client server 114 and the age verification system 116 to be able to associate the user's hashed and encrypted data with the user unique hash identifier, as well as with any other data that the client server 114 wants to keep track of, such as the user's activity, purchase history, and habits. In addition, this user unique hash identifier may also be associated with the client's information such as the time stamps of transactions, store location, terminal/computing device identification number, and so on. This allows the user 102 to stay completely anonymous, but also enables the client to have complete access to the user's generated data if needed. One approach to generating this user unique hash identifier is to use a cryptographically secure random number generator to generate a sufficiently long string of random bytes, which may then be converted to a hexadecimal or base 64 representation for storage and transmission. This ensures that each user's user unique hash identifier is unique and sufficiently random to prevent guessing or cracking. In other words, the user device 104 may generate the user unique hash identifier using one or more processes and/or algorithms such as a cryptographically secure random number generator, which generates a sufficiently long string of random bytes. The user device 104 may further convert this to a hexadecimal or base 64 representation for storage and transmission to the age verification system 116.

For instance, these hashed and encrypted values (e.g., the user unique hash identifier, the user's mobile phone number, the user email address) of the user's information may be sent onto the age verification system 116, via the secure network 106. To achieve the utmost security of the data during the transfer, the user application 108 (e.g., the user device 104) may utilize a secure communication channel that may be encrypted with technologies such as: TLS/SSL to prevent eavesdropping and man-in-the-middle attacks similar to previous steps. In other words, the user device 104 provides enrollment information such as the hashed and/or encrypted values and/or the hashed unique identifier for the user device 104 to the age verification system 116.

Following that, the age verification system 116 (e.g., the check processor 302) checks whether the specific unique identifier (e.g., the hashed unique identifier) exists on the pending verification database 608 and/or the verified users database 610.

If the unique identifier exists on the verified users database 610, this may indicate that the specific user's hashed and encrypted values (e.g., the user unique hash identifier, the user's mobile phone number, the user email address), were either previously used by another user (ex-phone user/used phone) owning the same user device 104, or that the user application 108 has been reset. As a result, the age verification process is to be completed again for the specified user 102. Therefore, the user's hashed and encrypted values (e.g., the user unique hash identifier, the user's mobile phone number, the user email address) alongside the unique identifier now needs to be written into the pending verification database 608 and deleted from the verified users database 610. In other words, the age verification system 116 determines whether the unique identifier exists in the verified users database 610 already. If so, this may indicate that the user device 104 was previously used by another user and/or the user application 108 has been reset for this user device 104. As such, the age verification system 116 deletes the information (e.g., the user's hashed and encrypted values as well as the unique identifier) from the verified users database 610 and includes this information into the pending verification database 608 (e.g., the user device 104 is no longer verified and the user device 104 as well as the user 102 needs to be re-verified).

If the unique identifier of the user device 104 exists in the pending verification database 608 or in none of the two databases 610, 608, the user's hashed and encrypted values alongside the unique identifier of the user device 104 is now be written into the pending verification database. In other words, if the unique identifier of the user device 104 exists in the pending verification database 608 already or is not in either of the databases 608, 610 (e.g., the unique identifier is not on the whitelist or the yellow list), then the age verification system 116 generates an entry for the unique identifier, which may include the user's hashed and encrypted values (e.g., the user unique hash identifier, the user's mobile phone number, the user email address), into the pending verification database 608 (e.g., the user 102 and/or the user device 104 is to be verified by the client).

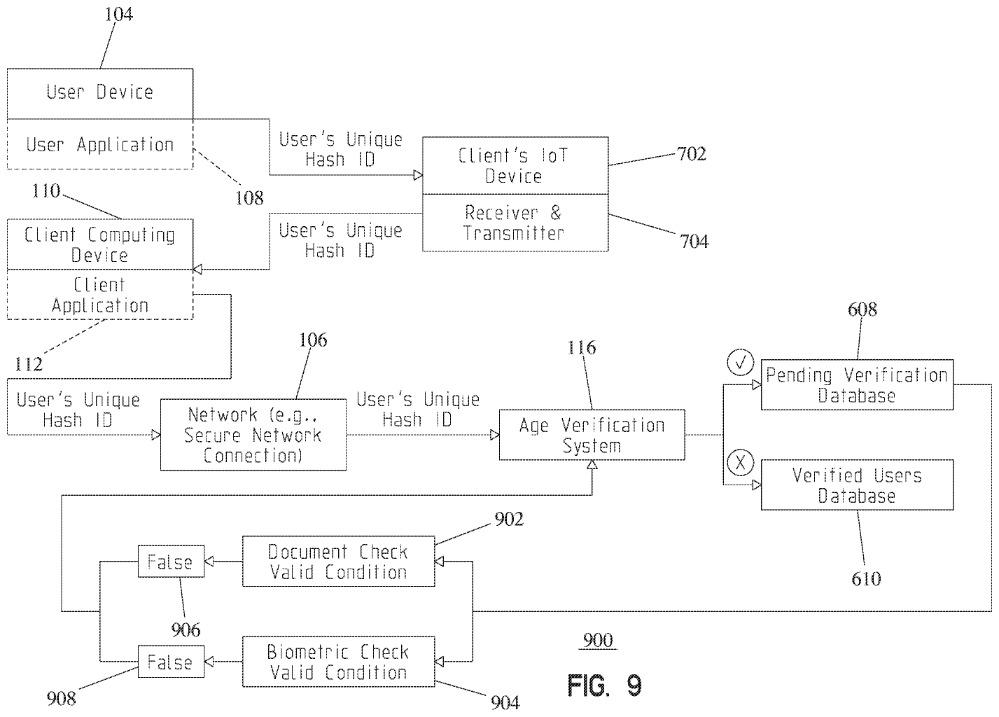

In some instances, the generated entry may include two label/conditional values/indicators (e.g., the document check valid condition 902 and the biometric check valid condition 904 shown in FIG. 9) that represent the state of the age verification process for each unique identifier. All this information is stored in the pending verification database 608 where the user unique hash identifier is residing, and the two conditional/label values/indicators are the document check valid indicator and the biometric check valid indicator. In other words, the age verification system 116 may generate two indicators (e.g., the document check valid indicator and the biometric check valid indicator) that is included in the pending verification database 608 along with the other information from the user 102 and/or the user device 104 (e.g., the unique identifier for the user device 104 and/or the user's hashed and encrypted values). The two indicators indicate whether certain processes (e.g., the biometric check process and the document check process have been completed).

Returning back to FIG. 5A, at block 506, the user device 104 provides the user's unique identifier (ID) via an IoT device to the client computing device 110. At block 508, the client computing device 110 provides the unique ID to the age verification system 116. At block 510, the age verification system 116 determines whether the user 102 is in the pending verification database 608. For instance, the user 102 may seek to engage in an age restricted activity such as a gambling activity. The user 102 may enter into a client establishment and/or access the client's services online. For example, the user 102 may enter a gambling facility that is owned, operated, and/or associated with a client. The user 102 may seek to engage in an age restricted activity (e.g., gambling) and the client may seek to check to ensure the user 102 is of legal age. As such, initially, at blocks 506-510, after the user 102 enters the client's establishment, the user device 104 provides the user's unique identifier via an IoT device to a client computing device 110, and the client computing device 110 forwards this unique identifier to the age verification system 116. The age verification system 116 checks (e.g., determines) whether the user 102 and/or the user device 104 is in the pending verification database 608. For instance, previously, in block 504, during the pre-verification process, the age verification system 116 may have generated and included the user's hashed and encrypted values and/or the user identifier for the user device 104 into the pending verification database 510.

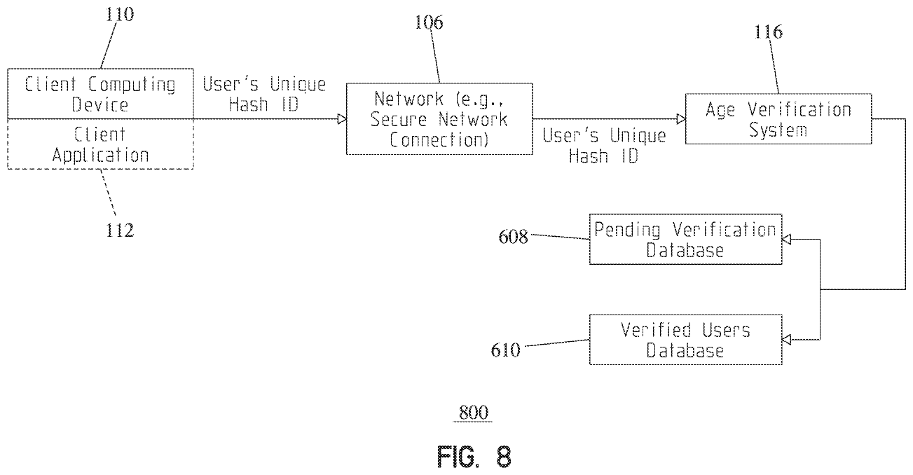

FIGS. 7-8 and processes 700-800 will describe blocks 506-510 in more detail. For example, referring to FIG. 7, once the user's hashed and encrypted values and the associated unique identifier for the user device 104, have successfully been saved on the secure age verification system 116, the user 102 still needs to pass the age verification process to be eligible to perform the age restricted activities (e.g., purchase the age restricted products or services of their choice). At the same time, the users 102 may use the user application 108 on their user device 104, to browse and select products they wish to purchase or browse around the retail store or self-service terminal, to choose their product or service of preference. When the users 102 are ready to make a purchase (e.g., online or brick-and-mortar), they will need to initiate an IoT action (e.g., NFC, quick response (QR) scan, barcode scan, Beacons, and/or other method such as MICROSOFT's authenticator for online transactions) on the client's IoT device 702 (e.g., a receiver and/or transmitter 704) connected to the client's application 112 through the client's computing device 110. In other words, when the user 102 is ready to engage in the age restricted activity, the user device 104 initiates an IoT action via the client's IoT device 702 to the client's computing device 110. For instance, the user device 104 may provide information such as the user's hashed and encrypted values and/or the associated unique identifier for the user device 104 to the client computing device 110 via the IoT action. In some instances, the user device 104 may provide the hashed unique identifier of the user device 104 to the client computing device 110.

In some instances, the IoT device 702 and/or the functions of the IoT device can be part of or performed by the client's computing device 110. In some examples, the functions of the IoT device can be performed by an NFC reader and/or a third party device to receive and/or send signals.

After initiating the IoT action from the user's side, the client application 112 (e.g., the client computing device 110) receives the IoT signal message, that the user application 108 generated on the user device 104. The user device 104 transmits the generated unique identifier (e.g., the hashed unique identifier), to the client application 112 using a secure communication channel. This communication channel may be encrypted using technologies such as: transport layer security (TLS)/secure sockets layer (SSL) to prevent eavesdropping and man-in-the-middle attacks as described in previous steps. Since the client application 112 receives the encrypted unique identifier from the user application 108, before sending it over the network 106 to the age verification system 116, it is ensured that the user's data is protected in case any of the databases or systems residing on the age verification system 116 or the client server 114 are compromised. In other words, the client computing device 110 receives the IoT signal message (e.g., the hashed unique identifier) from the user device 104, and provides the hashed unique identifier to the age verification system 116.

Referring to FIG. 8, at this stage, the first step of the Age Verification Engine (e.g., the age verification system 116) is triggered. In this part, the hashed unique identifier that was generated at an earlier stage, is also now encrypted. For instance, the user device 104 and/or the client computing device 110 may encrypt the hashed unique identifier prior to sending it to the age verification system 116. Then, it is sent over the network 106 from the client application 112 through their client computing device 110, to the age verification system 116 (e.g., the check processor 302). The age verification system 116 checks if the hashed unique identifier exists in either one of the two databases (e.g., the verified users database 610 and/or the pending verification database 608).

In the case where the specific hashed unique identifier does not exist in the verified users database 610, after the check processor 302 performs the appropriate check, but does exist in the pending verification database 608, and the document check valid condition (e.g., the document check indicator) associated with the hashed unique identifier is not fulfilled (e.g., set to false), then the second step of the verification process is triggered. This step involves triggering the age verification system 116 (e.g., the document identification processor 304) to perform a document check (e.g., through an automated script that runs on the age verification system 116). In other words, based on the hashed unique identifier received from the user device 104 via the client computing device 110 (e.g., from blocks 506 and 508) being in the pending verification database 608, the age verification system 116 performs a document check process.

In this step, the user 102 with the specified marked hashed unique identifier, that is attempting to complete the age verification process and purchase the product and service of their choice, as well as the entity authorized by the client, that is assisting the user 102 on the age verification process, may receive a message response from the age verification system 116 (e.g., the document identification processor 304) through the network 106. This message may be received by both the client application 112 on the client computing device 110, as well as the user application 108 on their respective user device 104, which triggers the ID document check process to begin on their devices 104 and 110. This is explained in block 512.

Referring back to FIG. 5A, at block 512, the age verification system 116 provides a document check request. For instance, based on determining that the hashed unique identifier is in the pending verification database 608 (e.g., the user 102 performed the pre-verification process, but has not been verified that they are of legal age to perform the age restricted activity), the age verification system 116 performs a document verification process. As such, at block 512, the age verification system 116 provides a document check request. The document check request may be a message to the user device 104 and the client computing device 110 for the user 102 to show their ID authentication document (e.g., a driver's license, passport, government ID document, and/or other document that verifies the age of the user 102) to an authorized entity for further examination. This is described above.

Referring to FIG. 5B, at block 514, the client computing device 110 provides a result of the document check. For instance, the authorized entity may check the user's 102 ID authentication document (e.g., passport). Based on the check, the client computing device 110 may prompt a response such as the ID authentication document indicates the user 102 is of legal age to perform the age restricted activity or is not of legal age to perform the age restricted activity. The authorized entity may provide an input on the client computing device 110, and the client computing device 110 may provide the result (e.g., the input) to the age verification system 116. In some instances, the result might not include and/or indicate the user's ID authentication document (e.g., passport). In other words, the result may be an indicator as to whether the user is of legal age, but might not include any information associated with the user's ID authentication document (e.g., might not include the user's ID authentication document, an encrypted version of the ID authentication document, and/or portions of data of the ID authentication document).

At block 516, the age verification system 116 updates the pending verification database 608 based on the result. For instance, as mentioned above, the hashed unique identifier for the user device 104 may be associated with and/or include indicators such as a document check valid indicator and the biometric check valid indicator. Initially, these indicators may be set to false in the pending verification database 608. Based on the result from block 514, the age verification system 116 may update the pending verification database 608 such as by changing one of the indicators (e.g., the document check valid indicator) to true. For instance, by changing the indicator to true, the age verification system 116 may indicate that the user 102 and/or the user device 104 has successfully completed performance of the document check. At block 518, the age verification system 116 generates and provides a unique age verification identifier to the client server 114. FIGS. 9-12B and processes 900-1200 will be used to describe blocks 514-518 in further detail.

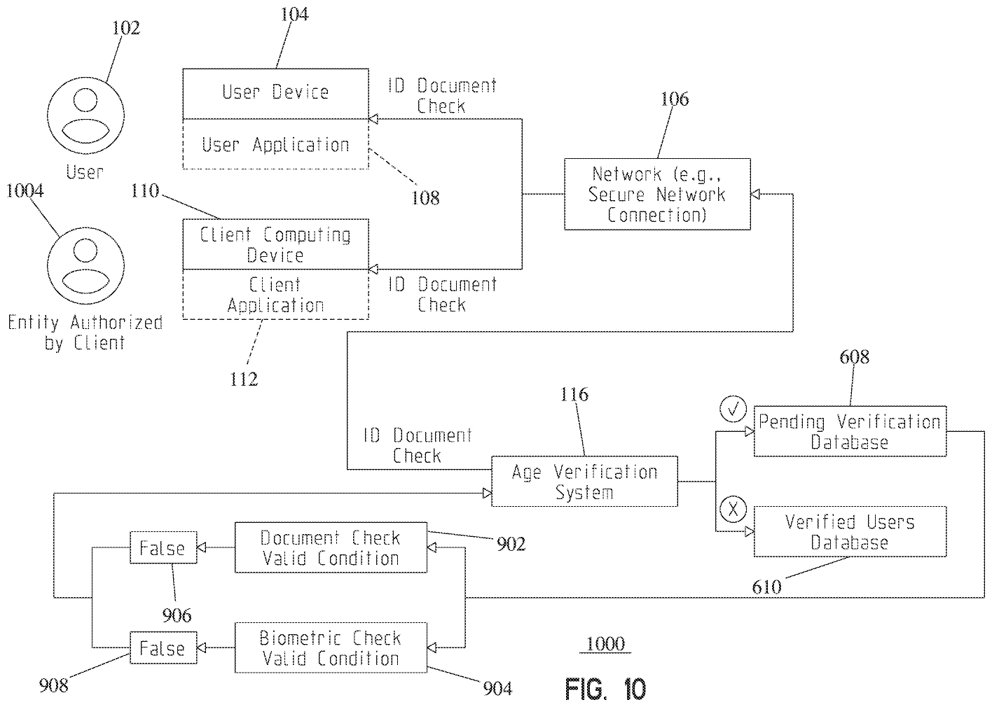

For instance, referring to FIGS. 9 and 10, during this process, the age verification system 116 provides a request to the client application 112 and/or the user application 108 to perform the document check based on the indicators 902, 904 for the document check and the biometric check being false 906, 908. For instance, based on the user's unique hash ID, from the user device 104 to the age verification system 116 via the network 106, the client computing device 110, and the client's IoT device 702, not being in the verified users database 610 and being in the pending verification database 608, the age verification system 116 may check and determine that the indicators 902 and 904 are false 906, 908. Then, based on these indicators 902, 904 being false 906, 908, the user 102 is prompted through the user application 108 on their user device 104, to provide to the entity authorized by the client 1004, their ID authentication document (e.g., a government issued ID). The entity authorized by the client 1004 is prompted through their client application 112 on their client computing device 110, to check the specified user's ID authentication document and press the corresponding options that appear on the screen of the client computing device 110 through the client application 112. This allows the entity authorized by the client to confirm whether the ID authentication document provided by the user 102 is valid and qualifies (e.g., over the legal age to perform the age restricted activity).

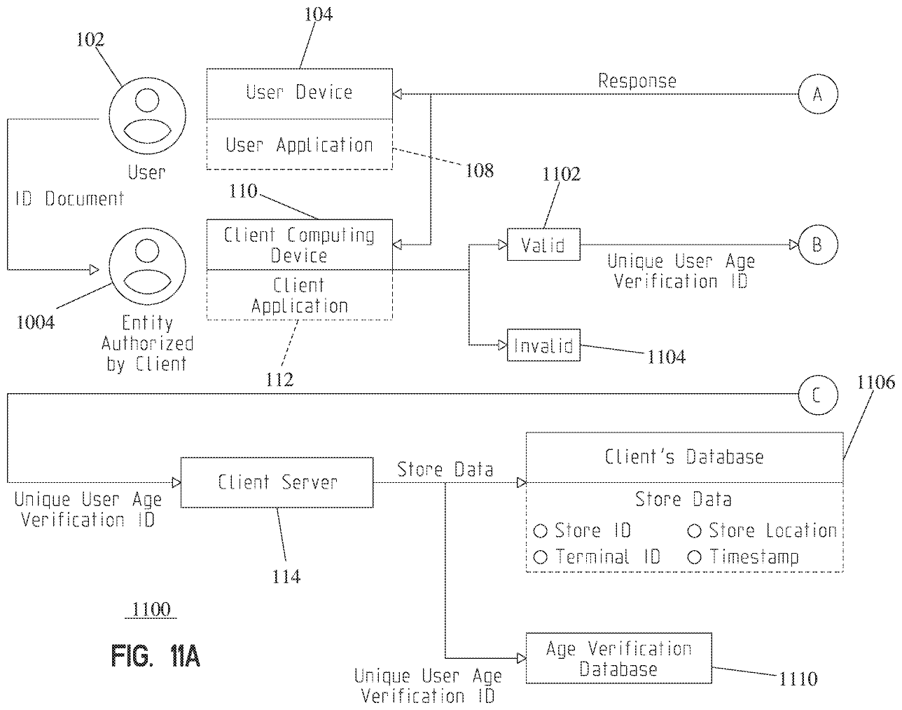

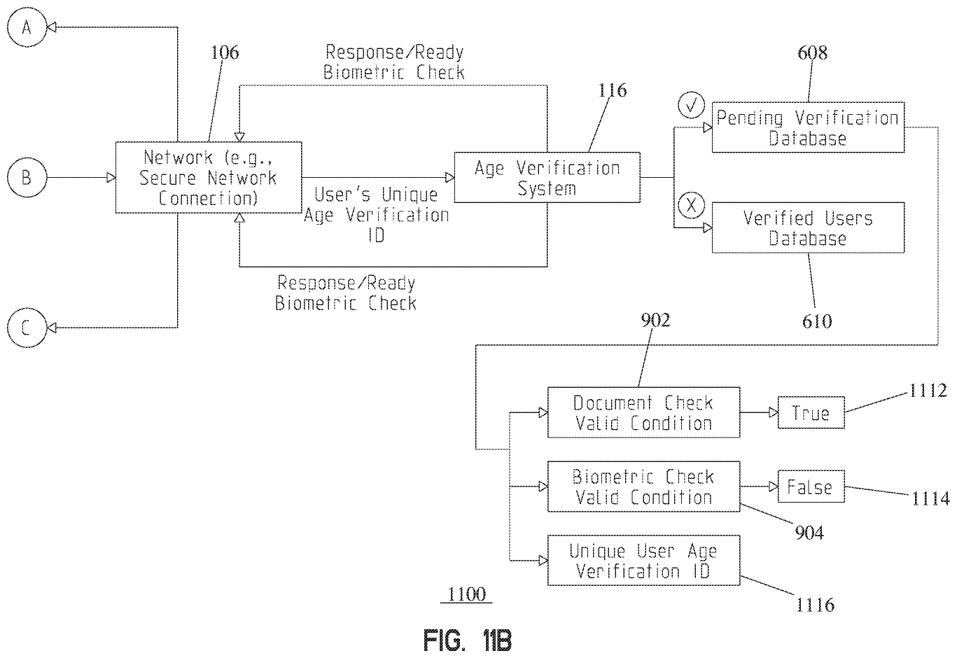

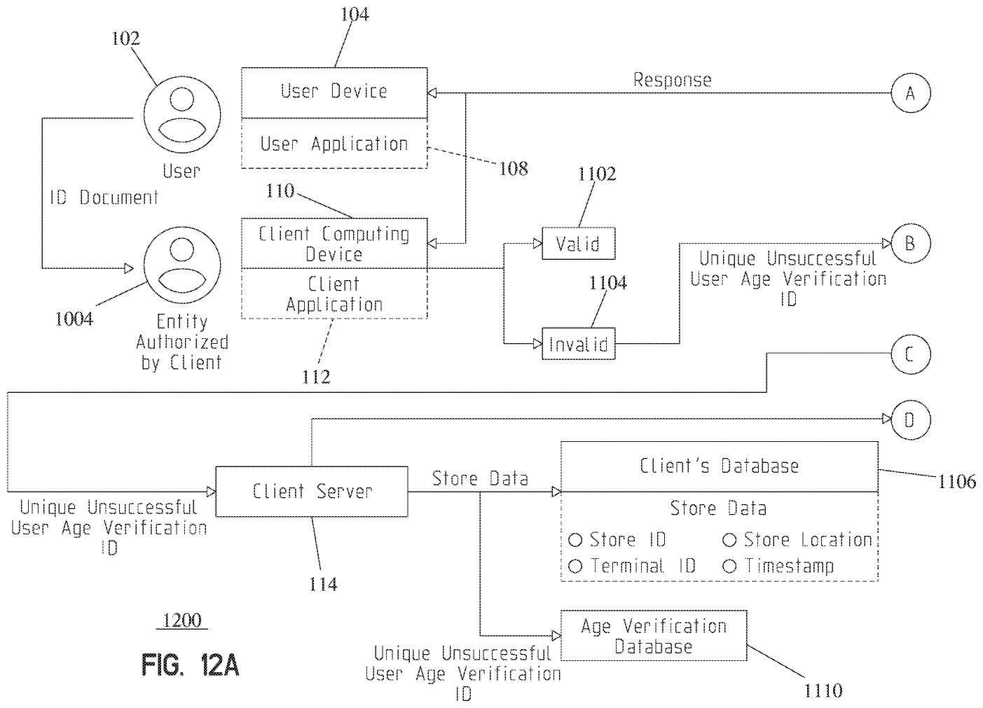

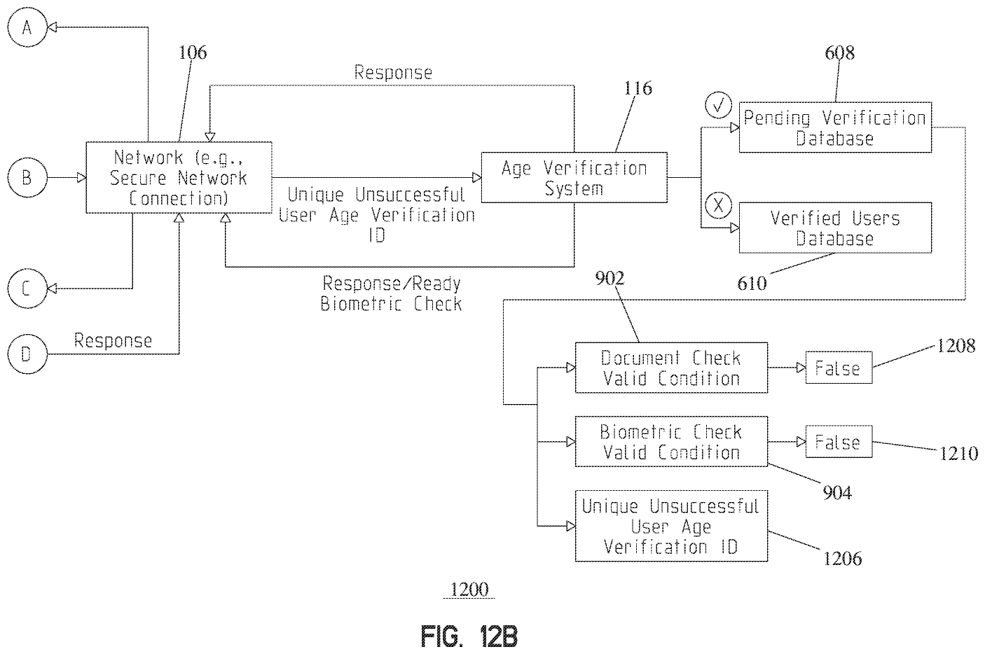

Referring to FIGS. 11A, 11B, 12A, and 12B, in the case where the ID authentication document provided to the entity authorized by the client, is valid and qualifies for the age restricted activity (e.g., products or services), the entity authorized by the client 1004 proceeds through the client application 112 on their client computing device 110, by pressing the option that the user qualifies and may be prompted to double confirm their option to avoid any mistakes. In other words, the client computing device 110 may receive one or more inputs (e.g., valid 1102 or invalid 1104) from the authorized entity indicating whether the user 102 is of legal age to perform the age restricted activity. The user input indicating valid 1102 is described in FIGS. 11A and 11B, and the user input indicate indicating invalid 1104 is described in FIGS. 12A and 12B.

In some instances, the client computing device 110 (e.g., the client application 112) collects additional data for the user 102 (e.g., the necessary relevant data and information about the age verification process of the specific user 102, in relation to the interaction with the entity authorized by the client). This data and information is retrieved on the client application 112 from the client server 114 through the network 106. This data may range from, the store ID, device or self-service terminal ID, the store's, device's or self-service terminal's location, the timestamp at which the age verification occurred, and/or any other data that the client wants to associate with the specific age verification process, as well as the entity authorized by the client ID credentials, that is performing the user's age verification process at the physical location. This allows the client to keep track of any fraudulent acts or mistakes that may occur during this process, and the data/information is stored in the client's database 1106 and/or the age verification database 1110. In other words, the client computing device 110 may receive certain information such as the store ID and/or the ID credentials of the entity authorized by the client (e.g., the credentials of the person that is performing or checking the document of the user 102) from the client server 114 via the client's database 1106 and/or the age verification database 1110.

The client application 112 on the client computing device 110 also generates a unique user age verification identifier 1116 for the specific successful document check process of the user 102. This generated unique user age verification identifier 1116 may be sent from the client application 112 on the client computing device 110, through the network 106, to the secure age verification system 116, to be stored and associated to the user's hashed unique identifier for the user device 104. This way, the client may request from the secure age verification system 116, which user successfully completed the process for the specific unique user age verification identifier if needed. All the client related data that is retrieved from the client server 114 through the network 106, as well as the generated unique user age verification identifier from the client application 112, is also securely stored with the encryption methods described in previous steps, to the client server 114 through the network 106. This is stored in a separate database (e.g., the age verification database 1110), but is now linked with the specific user through the secure age verification system 116 using the unique user age verification identifier. This way, the client server 114 as well as the age verification system 116 may associate the commonly shared unique user age verification identifier 1116 with the unique identifier of the user device 104 alongside the client's data and other information collected from the client's application 112 as described before.

Finally, this may be sent over the network 106 and back to the age verification system 116, from the client application 112 a positive response, which may mark the specified hashed unique identifier of the user device 104 that is now residing in the pending verification database 608 on the secure age verification system 116, and mark it as ready for the third and final stage, the user biometric authentication process. In order to initiate the next stage and for the user's hashed unique identifier to be marked as ready for the following stage, the document check valid condition/label/indicator 902 associated with the user's hashed unique identifier, is now marked as true 1112, which initiates the third stage of the age verification process through an automated script that runs on the secure the age verification system 116. In other words, based on the user's ID authentication document indicating the user 102 is of legal age to perform the age restricted activity, the client computing device 110 generates a new identifier for the user 102 (e.g., the unique user age verification identifier 1116) and obtains information associated with the user 102 from the client server 114. The client computing device 110 then provides information to the client server 114 and/or the age verification system 116. Based on the information, the age verification system 116 updates the pending verification database 608 such as by marking the document check valid condition/indicator 902 as true 1112 from false. The biometric check valid condition 904 still remains as false 1114. This begins the next process, which is the biometric check process.

Referring to FIGS. 12A and 12B, in the case where the ID authentication document provided by the user 102 to the entity authorized by the client is not valid or does not qualify for the age restricted activity (e.g., age restricted products or services), the entity authorized by the client 1004 proceeds on the client application 112 by pressing the option that the user 102 does not qualify (e.g., invalid 1104) and may be prompted to double confirm this option to avoid any mistakes.

This may send over the network 106 and back to the age verification system 116 as a negative response indicating invalid 1104 from the client application 112 on the client computing device 110. Through an automated script that runs on the secure age verification system 116, a response message may be triggered, which may be sent over the network 106, back to both the client application 112 on the client computing device 110, as well as on the user application 108 on their user device 104. This response message may alert both applications that the ID authentication document provided by the user 102 during the document check has failed, and that the whole process of verifying the user's age needs to be completed again from the beginning. As a result, the user's hashed unique identifier still remains active in the pending verification database 608 residing on the secure age verification system 116, in order for the process to be completed from the beginning. At this stage, the user's hashed unique identifier for the user device 104 might not marked as ready for the following stage and the document check valid condition/label/indicator 902 associated with the user's hashed unique identifier on the pending verification database 608 residing on the secure age verification system 116, is marked as false 1208 through an automated script that runs on the secure age verification system 116. This may not initiate the third stage of the age verification process (e.g., the process of verifying the user's age may have to be repeated from the very beginning). In other words, in the event that the document check fails (e.g., the authorized entity indicates that the user 102 is not of legal age for the age restricted activity), the client computing device 110 provides a response (e.g., the document check has failed) to the age verification system 116. The age verification system 116 does not change the document check valid indicator 902 from false to true (e.g., this indicator remains false), which indicates that the age verification process may have to be repeated. The biometric check valid condition 904 remains as false 1210 and a unique unsuccessful user age verification ID 1206 may be stored alongside the two conditions 902, 904. To put it another way, if the authorized entity notes that the user 102 is not of legal age, the age verification system 116 obtains information indicating this. Thus, the user 102 is turned away from accessing the age restricted activity and may have to try again at a later time (e.g., when the user 102 becomes of legal age).

It should be noted that the client application 112 of the client device 110 may also collect all the necessary relevant data and information about the age verification process of the specific user 102, in relation to the interaction with the entity authorized by the client. This data and information may be retrieved on the client application 112 of the client device 110 from the client server 114 through the network 106 and stored in the client's database 1106 and/or the age verification database 1110. This data can range from, the store ID, device or self-service terminal ID, the store's, device's or self-service terminal's location, the timestamp at which the Age Verification occurred, or any other data that the client wishes to associate with the specific age verification process, as well as the entity's authorized by the client ID credentials (e.g., the credentials of the authorized entity such as the person that is checking the user's 102 ID) that is performing the user's Age Verification Process at the physical location. This may allow the client to keep track of any fraudulent acts or mistakes that may occur during this process.

The client application 112 of the client device 110 may also generate a unique unsuccessful user age verification ID 1206 for the specific unsuccessful document check process of the user 102. This generated unique unsuccessful user age verification ID 1206 may be sent from the client application 112 of the client device 110, through the network 106, to the secure age verification system 116, to be stored and associated to the user's hashed unique ID. This way, the client may request from the secure age verification system 116, which user 102 failed the process of verifying their ID document for the specific unique unsuccessful user age verification ID 1206 if needed. The client related data that is retrieved from the client server 114 through the network 106, as well as the unique unsuccessful user age verification ID 1206 from the client application 112, is also securely stored with the encryption methods described in previous steps, to the client server 114 through the network 106. This may be stored in a separate database (e.g., the age verification database 1110) but is now linked with the specific user through the age verification system 116 using the unique unsuccessful user age verification ID. This way, the client server 114 as well as the age verification system 116 may associate the commonly shared unique unsuccessful user age verification ID 1206 with the user's hashed unique identifier for the user device 104 alongside the client's data and other information collected from the client's application as described before. This may indicate that either the entity authorized by the client has performed a human error during the document check process, or that the user 102 displayed an ID authentication document that is either not eligible or fraudulent.

The respective sanctions for this failed attempt may be easily applied by the client according to the company needs, as this unsuccessful attempt to verify the user's document is now associated between the two servers (e.g., the client server 114 and the age verification system 116) with the user's hashed unique identifier via the unique unsuccessful user age verification ID.

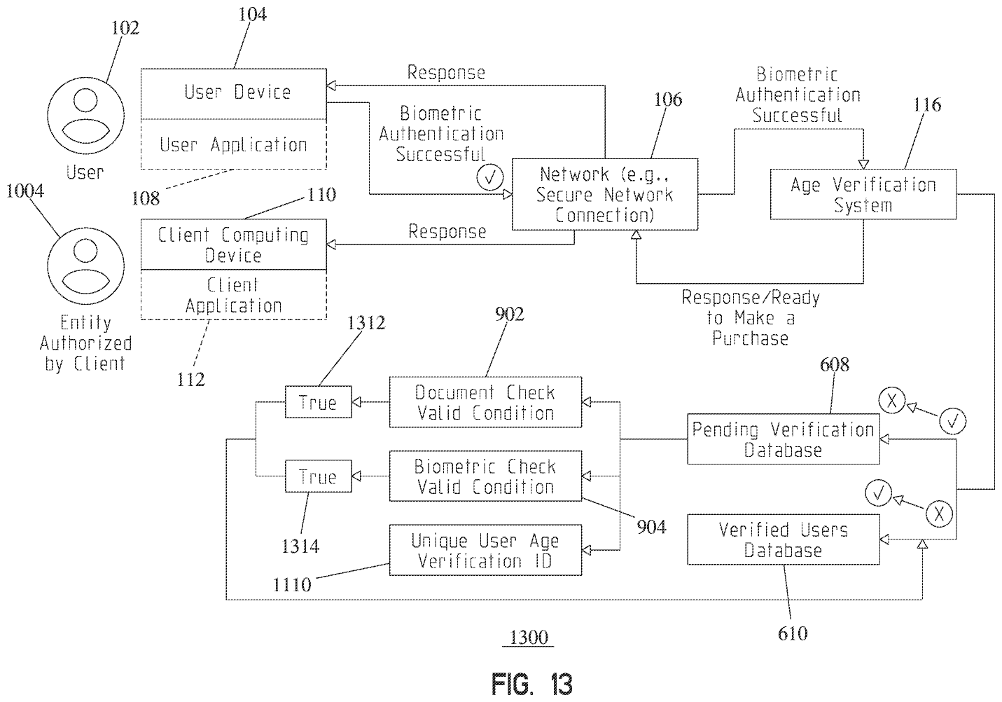

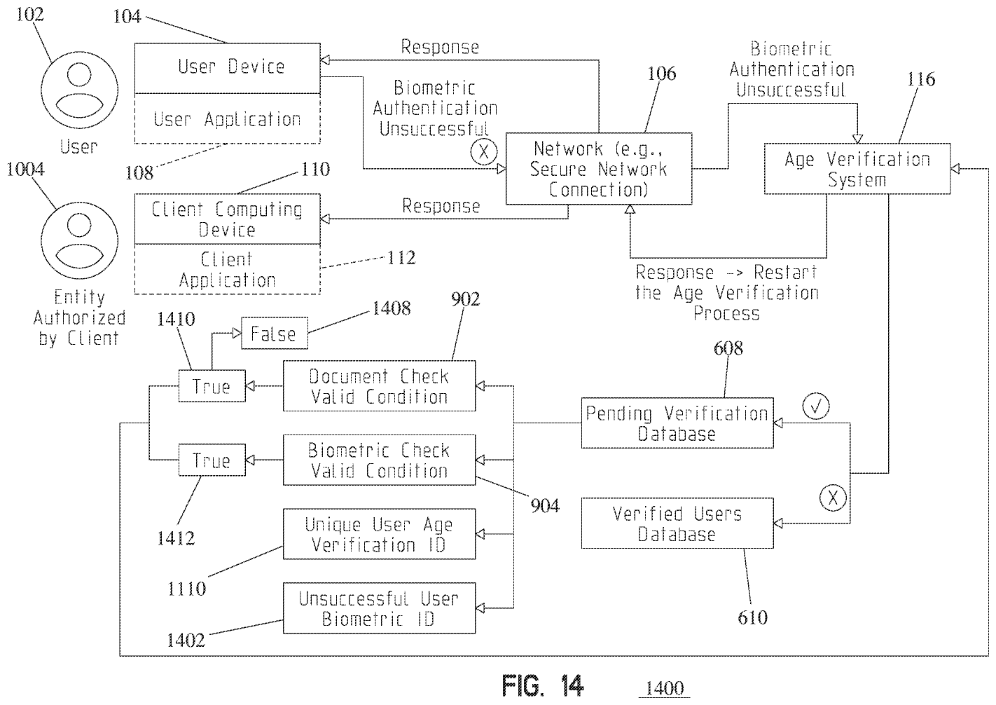

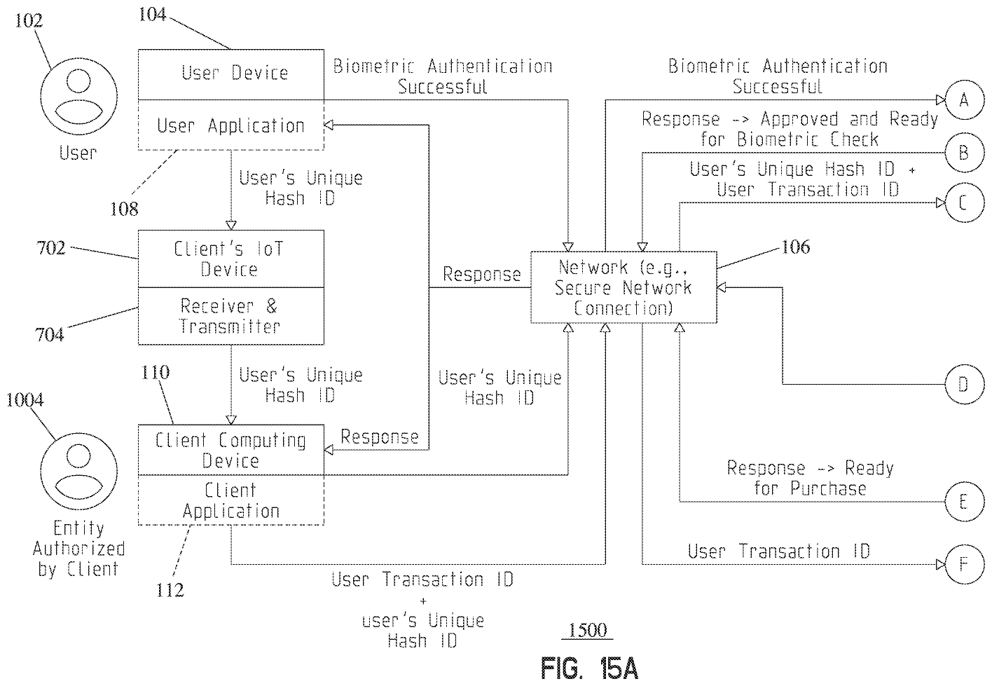

Referring back to FIG. 5B, based on the result of the document check succeeding, the age verification system 116 initiates the biometric check process. For instance, at block 520, the age verification system 116 provides a biometric check request to the user device 104. The user device 104 may perform a biometric check to determine whether the user 102 owns and/or is permitted to use the user device 104. At block 522, the user device 104 provides a result of the biometric check to the age verification system 116. At block 524, the age verification system 116 updates the verification databases based on the result. For instance, as mentioned above, the pending verification database may include one or more indicators for the hashed unique identifier for the user device 104 such as a biometric check valid indicator. Based on the result being positive (e.g., the user 102 passes the biometric check on the user device 104), the age verification system 116 may update the pending verification database 608 such as by changing one of the indicators (e.g., the biometric check valid indicator) to true. For instance, by changing the indicator to true, the age verification system 116 may indicate that the user 102 and/or the user device 104 has successfully completed performance of the biometric check. Referring to FIG. 5C, at block 526, the age verification system 116 generates and provides a unique age verification identifier to the client server 114. FIGS. 13 and 14 and processes 1300 and 1400 will be used to describe blocks 522-526 in more detail.

For instance, referring to FIG. 13, in the case where the specific user's hashed unique identifier exists on the pending verification database 608 residing on the secure age verification system 116 after the check processor 302 performs the appropriate check on the databases, and the associated document check validation check 902 that resides alongside the user's hashed unique identifier is fulfilled successfully (set to true 1312), then the third and final step of the age verification process is triggered through an automated script that runs on the secure age verification system 116. This step involves the use of the biometric identification processor 306 that also resides on the secure age verification system 116. For this action to occur, the specified user's hashed unique identifier is marked as ready for biometric check, through an automated script that runs on the secure age verification system 116.

In this step, the user 102 on the user application 108 on the user device 104 with the specified marked user's hashed unique identifier may receive a response message from the age verification system 116 (e.g., the biometric identification processor 306) that also resides on the secure the age verification system 116, triggering the user to perform a biometric authentication check on their user device 104 through the user application 108. Additionally, the entity authorized by the client may also receive a similar response message to the client application 112 on the client computing device 110, which may update them on the user's age verification process and notify them that the user 102 is ready to perform the biometric check through their user application 108.

In the case where the biometric test is successful and the appropriate success message is generated from the user device 104 through the user application 108, the final stage and initiation of the completion of the age verification process is triggered. As a result, the appropriate success response message may be sent from the user application 108 to the age verification system 116 via the network 106, for the biometric check valid condition/label/indicator 904 associated with the user's hashed unique identifier to be marked as true, using an automated script that runs on the secure age verification system 116 via the biometric identification processor 306. This may also move the specified user's hashed unique identifier from the pending verification database 608 to the verified users database 610 both of which may reside on the secure age verification system 116. In other words, based on the biometric test being successful, the age verification system 116 may receive the result indicating the success from the user device 104. Subsequently, the age verification system 116 may update the pending verification database 608 by changing the biometric check valid condition/label/indicator 904 associated with the user's hashed unique identifier to be marked as true 1314. Further, the age verification system 116 may move the user's hashed unique identifier from the pending verification database 608 to the verified users database 610.

From now on, the user's hashed unique identifier is marked as age verified and now belongs to the verified users database 610 residing on the secure age verification system 116. Through an automated script that runs on the secure age verification system 116, a response message may be triggered, which may be sent over the network 106, back to the entity authorized by the client through the client application 112 on the client's computing device 110, as well as on the user application 108 on their user device 104 notifying them that the specific user 102 has successfully completed the age verification process and is now eligible to perform the age restricted activity (e.g., perform any desired purchases of an age restricted product or service). Therefore, the user device 104 and the user application 108 are now fully unlocked and eligible to perform the age restricted activity by simply performing a biometric authentication check through their user application 108 on the user device 104, prior to performing any additional age restricted activities (e.g., purchasing their preferred product or service in the future).

Referring to FIG. 14, in the case where the biometric authentication process is not successful (e.g., one or more unsuccessful attempts), the appropriate failure message response is generated from the user device 104 through the user application 108. This failed message response may now be sent to the age verification system 116 via the network 106. Through an automated script that runs on the age verification system 116 via the biometric identification processor 306, a response message may be triggered which may be sent over the network 106, back to the entity authorized by the client through the client application 112 on the client device 110, as well as on the user application 108 on the user device 104, that the biometric check has failed after several attempts and that the whole process of verifying the user's age needs to be completed again from the beginning. As a result, the user's hashed unique identifier remains active in the pending verification database 608 residing on the secure age verification system 116. Additionally, the two labels/conditions/indicators 902, 904 associated with the specific user's hashed unique identifier, may now be reset back to their default values for the process to be completed from the beginning (e.g., both set to false 1408, 1412). For instance, the document check valid condition 902 may also be set from true 1410 back to false 1408. In other words, based on the biometric check failing, the age verification system 116 may receive a result indicating this form the user device 104. The age verification system 116 may set both indicators 902, 904 to false 1408, 1412 indicating for the user 102 to reset the process.

It is important to highlight that these repeated unsuccessful attempts generated from the failed biometric authentication test through the user application 108 on the user device 104 may generate a unique unsuccessful user biometric authentication ID 1402 for the specific user's unsuccessful biometric authentication. This generated unique unsuccessful user biometric authentication ID 1402 may be sent from the user application 108 on the user device 104, through the network 106, to the secure age verification system 116, in order to be stored and associated to the user's hashed unique identifier. This unique unsuccessful user biometric authentication ID 1402 is also securely stored with the encryption methods described in previous steps, to the client server 114 through the network 106. This is stored in a separate database, but is now linked with the specific user through the age verification system 116 using the unique unsuccessful user biometric authentication ID. This way, the client server 114 as well as the age verification system 116 may associate the commonly shared unique unsuccessful user biometric authentication ID 1402 with the user's hashed unique identifier alongside the client's data and/or other information collected from the client's application (e.g., the unique user age verification ID 1110) as described before.

This way, the client can request from the secure age verification system 116, which users have failed the process of performing the biometric authentication on their device. This may indicate that the user attempting to register may not be the owner of the user device 104.

The respective sanctions for the repeated failed attempts from the user 102 may be easily applied by the client according to the company needs, as they are now associated with the user's hashed unique identifier through the generated unique unsuccessful user biometric authentication ID that is commonly shared between the age verification system 116 and the cloud server 114.

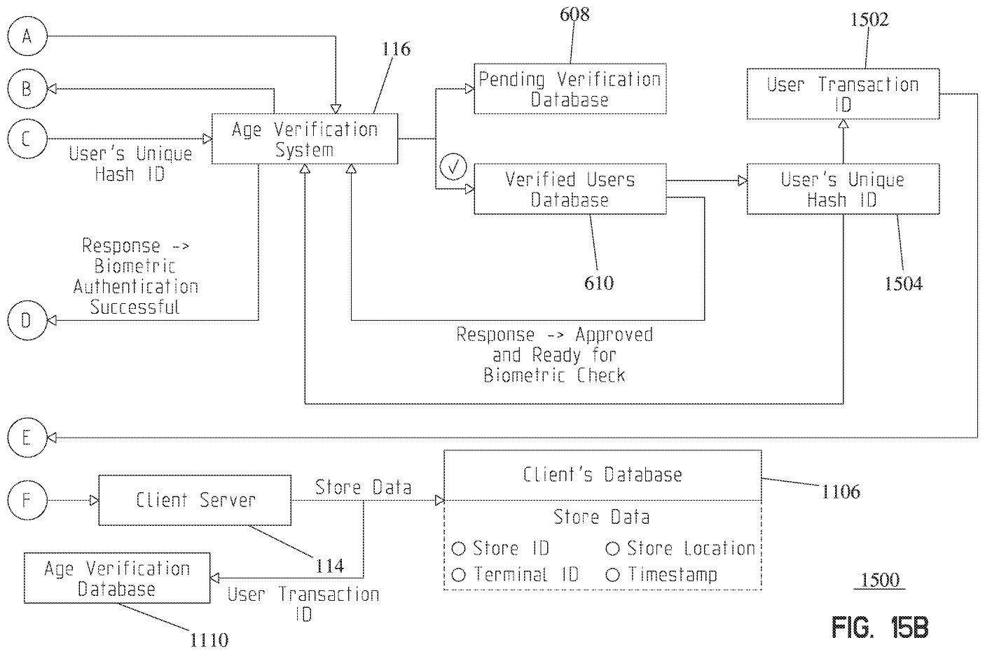

Returning back to FIG. 5C, at block 528, the age verification system 116 provides a confirmation response such as indicating that the user 102 passed both the document check process and the biometric check process. The confirmation response may indicate that the user 102 is allowed to perform the age restricted activity (e.g., gambling). At block 530, the user device 104 performs actions based on the confirmation. For instance, the user device 104 may display a prompt indicating the user 102 is allowed to perform the activities and/or actually perform the activities (e.g., if the activity is online, the user device 104 may be allowed to purchase age restricted products and/or services). At block 532, the user device 104 performs post age verification processes. Blocks 528-532 will be described in more detail in FIG. 15 and process 1500.

Referring to FIG. 15, finally, once the users are ready to make a purchase (online or brick-and-mortar) after they have completed the age verification process, they may need to initiate an IoT action (e.g., NFC, QR scan, Beacons, barcode scan, and so on) on the client's IoT device (e.g., receiver and/or transmitter) connected to the client application 112 on the client device 110. In the case where the specific user's hashed unique identifier exists on the verified users database 610 residing on the age verification system 116, following the appropriate check that the check processor 302 performs, residing on the age verification system 116, the specified user's hashed unique identifier is now marked as ready for biometric check in order to perform the age restricted activity (e.g., purchase said product or service), through an automated script that runs on the age verification system 116 via the biometric identification processor 306.

In this step, the user 102 on the user application 108 on the user device 104 with the specified marked hashed unique identifier may receive a response message from the biometric identification processor 306, triggering the user 102 to perform a biometric authentication check on their user device 104 through their user application 108. Additionally, the entity authorized by the client may also receive a similar response message to the client application 112 on the client computing device 110, which may update them that the user is currently age verified and should perform the biometric authentication process in order to proceed with the age restricted activity (e.g., purchasing the preferred product or service).

In the case where the biometric authentication process is successful and the appropriate success message is generated from the user device 104 through their user application 108, the appropriate success message may be sent from the user application 108 to the age verification system 116 via the network 106. Through an automated script that runs on the age verification system 116 via the biometric identification processor 306, a successful response message may be triggered which may be sent over the network 106, back to the entity authorized by the client through the client application 112 on the client computing device 110, as well as on the user application 108 on their user device 104 notifying them that the biometric check has been approved on the user device 104. This may enable the client application 112 on the client computing device 110 to unlock the age restricted service or product for the user 102. Thus, with the same success message response, the user application 108 on their user device 104 may allow the user to perform the age restricted activity (e.g., make the respective age restricted purchase of product or service), which completes the transaction process. In some instances, during the performance of the age restricted activity, the client application 112 on the client computing device 110 may generate a unique user transaction ID 1502 for the specific successful purchase of the user's preferred product or service. This unique user transaction ID 1502 may be sent to the age verification system 116 via the network 106 in order to be associated with the specific user's hashed unique identifier 1504, which may be used to keep track of the products and services that the specific user 102 is purchasing. At the same time, the same unique user transaction ID 1502 may also be sent over to the client server 114 via the network 106. This way, it is ensured that the client can request a specific user's purchasing history using the commonly shared unique user transaction ID, which is now shared between the age verification system 116 and the client server 114.

In the case where the biometric authentication test is repeatedly unsuccessful, the appropriate failed message may be sent to the age verification system 116 through the network from the user device 104 through their user application 108. Through an automated script that runs on the age verification system 116 via the biometric identification processor 306, a failed response message may be triggered which may be sent over the network 106, back to the entity authorized by the client through the client application 112 on the client device 110, as well as on the user application 108 on the user device 104, notifying them that the biometric authentication check has failed and that the whole process of verifying the user's entity has not been completed.

In some instances, during the third stage of the age verification process, these repeated unsuccessful attempts generated from the failed biometric authentication test through the user application 108 on the user device 104 may be recorded and associated through the network 106, with the user's hashed unique identifier using the same generated unique unsuccessful user biometric authentication ID for the specific user's unsuccessful biometric authentication. This generated unique unsuccessful user biometric authentication ID is also securely stored with the encryption methods described in previous steps, to the client server 114 through the network 106. This is stored in a separate database (e.g., the age verification database 1110) but is now linked with the specific user through the age verification system 116 using the generated unique unsuccessful user biometric authentication ID. This may differ in terms of storage as these recordings may describe that the specific user that has already performed the age verification process but has failed to perform the biometric authentication test repeatedly.

As a result, the user's hashed unique identifier remains active in the verified users database 610 residing on the secure age verification system 116, in order for the process to be completed again. The respective sanctions for the repeated failed attempts from the user 102 may be easily applied by the client according to the company needs, as they are now associated with the user's hashed unique identifier through the generated unique unsuccessful user biometric authentication ID that is commonly shared between the client server 114 and the age verification system 116.

This completes the three step journey of the age verification process, which includes two different databases 608, 610 residing on the age verification system 116, three main processors 302-306 residing on the age verification system 116, two main conditions and labels for allowing the processors to sync during the age verification process associated with the user's hashed unique identifier on the pending verification database 608 residing on the age verification system 116, four different but uniquely generated IDs, that associate the failed processes with the user's hashed unique identifier and the purchasing history of the user 102, as well as specific algorithms and solutions that are responsible for ensuring the security of the data during transfer, storage as well as protecting the user's data at all costs. All the functionalities, modules and products may reside on the age verification system 116, which may hosted by one or more cloud services.

In some instances, the next time that a verified user attempts to make a purchase or use an age-restricted service, he/she may simply need to complete the biometric identification step (e.g., blocks 520-522 above), which may confirm that the user 102 which initially passed the age verification process is the same person that is attempting to make the purchase with the same user device 104 and user application 108 that was used to verify the identity of the user with the help of the entity authorized by the client assigned by the client.

A number of implementations have been described. Nevertheless, it will be understood that additional modifications may be made without departing from the scope of the inventive concepts described herein, and, accordingly, other examples are within the scope of the following claims. For example, it will be appreciated that the examples of the application described herein are merely exemplary. Variations of these examples may become apparent to those of ordinary skill in the art upon reading the foregoing description. The inventor expects skilled artisans to employ such variations as appropriate, and the inventor intends for the application to be practiced otherwise than as specifically described herein. Accordingly, this application includes all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

It will further be appreciated by those of skill in the art that the execution of the various machine-implemented processes and steps described herein may occur via the computerized execution of processor-executable instructions stored on a non-transitory computer-readable medium, e.g., random access memory (RAM), read-only memory (ROM), programmable read-only memory (PROM), volatile, nonvolatile, or other electronic memory mechanism. Thus, for example, the operations described herein as being performed by computing devices and/or components thereof may be carried out by according to processor-executable instructions and/or installed applications corresponding to software, firmware, and/or computer hardware.

The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the application and does not pose a limitation on the scope of the application unless otherwise claimed. No language in the specification should be construed as indicating any non-claimed element as essential to the practice of the application.

What is claimed is:

1. A method, comprising:
receiving, by an age verification system and from a client computing device via a user device, user data, wherein the user device is associated with a user and the client computing device is associated with a gambling activity;
comparing, by the age verification system, the user data with one or more lists, wherein the one or more lists are stored in one or more databases associated with the age verification system;
based on the comparison, providing, by the age verification system, one or more authorization requests to verify the user is of legal age for the gambling activity;
in response to providing the one or more authorization requests, obtaining, by the age verification system, verification information associated with the user; and
based on the verification information, providing, by the age verification system and to the client computing device, authorization information indicating the age of the user is of the legal age to perform the gambling activity.

2. The method of claim 1, wherein the user data indicates a unique identifier for the user device, an email associated with the user, and/or at least a portion of a phone number associated with the user.

3. The method of claim 2, wherein the user data and the verification information associated with the user does not include any additional personal information of the user, and wherein the unique identifier is a mobile phone identifier (ID).

4. The method of claim 2, further comprising:
encrypting, by the user device, the unique identifier, the email associated with the user, and/or at least the portion of the phone number;
generating, by the user device, the user data, wherein the user data comprises the encrypted unique identifier, the encrypted email, and/or at least the portion of the phone number; and
providing, by the user device and to the age verification system, the user data.

5. The method of claim 4, wherein encrypting the unique identifier, the email associated with the user, and/or at least the portion of the phone number is based on using one or more hashing algorithms.

6. The method of claim 1, wherein the one or more lists comprise a whitelist and a yellow list, wherein the whitelist is stored in a verified users database and the yellow list is stored in a pending verification database, wherein the whitelist indicates one or more first users that have been previously verified to be of the legal age to perform the gambling activity, and wherein the yellow list indicates one or more second users that are pending verification for performing the gambling activity.

7. The method of claim 6, wherein comparing the user data with the one or more lists comprises determining that the user is on the whitelist, wherein obtaining the verification information comprises obtaining biometric verification information indicating that the user passed a biometric process performed by the user device, and wherein providing the authorization information is based on determining the user being on the whitelist and the biometric verification information indicating that the user passed the biometric process performed by the user device.

8. The method of claim 6, wherein comparing the user data with the one or more lists comprises determining that the user is on the yellow list, wherein obtaining the verification information comprises:
receiving, from the client computing device, document verification information indicating the user passed a document identification check process;
receiving, from the user device, biometric verification information indicating that the user passed a biometric verification process performed by the user device, and
wherein providing the authorization information is based on determining that the user is on the yellow list, the document verification information indicating the user passed the document identification check process, and the biometric verification information indicating that the user passed the biometric verification process performed by the user device.

9. The method of claim 8, further comprising:
moving an entry associated with the user from the yellow list to the whitelist based on the document verification information and the biometric verification information.

10. The method of claim 1, further comprising:
based on the verification information associated with the user, obtaining one or more unique identifiers for the user; and
providing, to a client server, the one or more unique identifiers for the user.

11. The method of claim 10, wherein the verification information comprises document verification information indicating that the user passed a document identification check process and biometric verification information indicating that the user passed a biometric verification process, and wherein obtaining the one or more unique identifiers for the user comprises generating a first unique identifier for the user based on the document verification information and a second unique identifier for the user based on the biometric verification information.

12. The method of claim 10, further comprising:
based on the providing the one or more unique identifiers for the user, retrieving historical gambling activity data indicating previous gambling activities of the user;
determining a promotional offer for the user based on the historical gambling activity data and the gambling activity associated with the client computing device; and
generating, by the age verification system, the authorization information, wherein the authorization information comprises an indicator indicating that the age of the user is of the legal age to perform the gambling activity and the promotional offer.

13. The method of claim 1, wherein providing the one or more authorization requests comprises:
providing a document check request indicating for the client computing device to verify a identifier (ID) document for the user is valid and the user is of the legal age for the gambling activity, and
wherein obtaining the verification information comprises:
obtaining, from the client computing device, a document verification result indicating the user is of the legal age for the gambling activity and the ID document for the user is valid.

14. The method of claim 13, wherein providing the one or more authorization requests further comprises:
providing a biometric check request indicating that the user device belongs to the user, and
wherein obtaining the verification information comprises:
obtaining a biometric check result indicating that the user device belongs to the user.

15. The method of claim 1, further comprising:
receiving, from the user device, enrollment information indicating a first hashed value of a unique identifier associated with the user device and one or more second hashed values indicating a phone number or email address associated with the user;
comparing the enrollment information with the one or more lists;
generating an entry for the user, wherein the entry indicates the first hashed value and the one or more second hashed values; and
including the entry on the one or more lists.

16. The method of claim 1, wherein receiving the user data comprises receiving, by the age verification system and from the client computing device via the user device and a client internet of things (IoT) device, the user data.

17. An age verification system, comprising:
one or more processors; and
one or more non-transitory computer-readable mediums having processor-executable instructions stored thereon, wherein the processor-executable instructions, when executed by the one or more processors, facilitate:
receiving, from a client computing device via a user device, user data, wherein the user device is associated with a user and the client computing device is associated with a gambling activity;
comparing the user data with one or more lists, wherein the one or more lists are stored in one or more databases associated with the age verification system;
based on the comparison, providing one or more authorization requests to verify the user is of legal age for the gambling activity;
in response to providing the one or more authorization requests, obtaining verification information associated with the user; and
based on the verification information, providing, to the client computing device, authorization information indicating the age of the user is of the legal age to perform the gambling activity.

18. The age verification system of claim 17, wherein the user data indicates a unique identifier for the user device, an email associated with the user, and/or at least a portion of a phone number associated with the user.

19. The age verification system of claim 17, wherein the one or more lists comprise a whitelist and a yellow list, wherein the whitelist is stored in a verified users database and the yellow list is stored in a pending verification database, wherein the whitelist indicates one or more first users that have been previously verified to be of the legal age to perform the gambling activity, and wherein the yellow list indicates one or more second users that are pending verification for performing the gambling activity.

20. A non-transitory computer-readable medium having processor-executable instructions stored thereon, wherein the processor-executable instructions, when executed by one or more processors, facilitate:
receiving, from a client computing device via a user device, user data, wherein the user device is associated with a user and the client computing device is associated with a gambling activity;
comparing the user data with one or more lists, wherein the one or more lists are stored in one or more databases associated with an age verification system;
based on the comparison, providing one or more authorization requests to verify the user is of legal age for the gambling activity;
in response to providing the one or more authorization requests, obtaining verification information associated with the user; and
based on the verification information, providing, to the client computing device, authorization information indicating the age of the user is of the legal age to perform the gambling activity.
